(19) United States
(12) Patent Application Publication
(10) Pub. No.: US 2024/0078240 A1
(43) Pub. Date: Mar. 7, 2024

(54) METHODS, SYSTEMS, AND APPARATUSES FOR ANALYZING CONTENT

(71) Applicant: Comcast Cable Communications, LLC, Philadelphia, PA (US)

(72) Inventors: Ehsan Younessian, Philadelphia, PA (US); Md Mahmudul Hasan, Philadelphia, PA (US); Faisal Ishtiaq, Philadelphia, PA (US)

(21) Appl. No.: 17/903,640

(22) Filed: Sep. 6, 2022

(51) Int. Cl. G06F 16/2457; G06F 16/2458

(52) U.S. Cl. CPC G06F 16/24578; G06F 16/2477

(57) ABSTRACT

A computing device may determine a plurality of popular topics for a time period. The computing device may determine a plurality of content items associated with at least one of the plurality of popular topics. The computing device may determine an output time for each of the plurality of content items. The computing device may determine a ranking order for the plurality of content items. The ranking order may be based on the output time for each of the plurality of content items. The computing device may output or cause to be output an indicator of at least a portion of the plurality of content items in the ranking order.

### BACKGROUND

Content providers (e.g., content channels) generate and provide a variety of content (e.g., video, audio, data). The content from different content providers may cover the same or different subject matter. The subject matter of the content provided by a particular content provider and the context used to describe that subject matter may provide an indication of the issues and/or topics that the content provider and/or its viewing audience consider important. In certain situations, different content providers provide content covering the same subject matter from differing perspectives. The difference in perspective and the context in which the same subject matter is covered may also provide an indication of the different perspective that the different content providers or their viewing audience consider important.

### SUMMARY

It is to be understood that both the following general description and the following detailed description are exemplary and explanatory only and are not restrictive. Methods, systems, and apparatuses systems for analyzing content are described.

One or more content sources, such as content channels, may be selected and a computing device may determine words or phrases being used in content from each content channel during a recent period of time, such as the previous one to three days. The computing device may determine how often each word or phrase is used during that recent period of time. The computing device may also determine how often each of those words or phrases are used during a previous period of time, such as the last week, two weeks, or month. Those words or phrases that were used a certain number of times during the previous period of time may be removed from the group of words or phrases being evaluated or no further action may be taken with regard to those words or phrases. The remaining words or phrases for the particular content source may be organized based on how often the word or phrase was used during the recent period of time and sent to a user device.

This summary is not intended to identify critical or essential features of the disclosure, but merely to summarize certain features and variations thereof. Other details and features will be described in the sections that follow.

### BRIEF DESCRIPTION OF THE DRAWINGS

The accompanying drawings, which are incorporated in and constitute a part of the present description serve to explain the principles of the apparatuses and systems described herein:

FIG. 1 shows an example system for analyzing content;

FIG. 2 shows a flowchart of an example method for determining content items related to popular topics;

FIG. 3 shows a flowchart of an example method for determining content items related to popular topics;

FIG. 4 shows a flowchart of an example method for determining content items related to popular topics;

FIG. 5 shows a flowchart of an example method for analyzing topics within the content;

FIG. 6 shows an example output of the analysis of the content;

FIG. 7 shows a flowchart of an example method for analyzing word usage in the content;

FIG. 8 shows a block diagram of an example determination of the first plurality of words or phrases in the content;

FIG. 9 shows a flowchart of an example method for determining words within the content;

FIG. 10 shows a flowchart of an example method for removing words or phrases identified in the content from analysis;

FIG. 11 shows a flowchart of another example method for removing words or phrases identified in the content from analysis;

FIG. 12 shows a flowchart of another example method for removing words or phrases identified in the content from analysis;

FIG. 13 shows an example output of the analysis of the content;

FIG. 14 shows another example output of the analysis of the content;

FIG. 15 shows a flowchart of an example method for analyzing word usage in a plurality of content;

FIG. 16 shows a flowchart of another example method for analyzing word usage in the content;

FIG. 17 shows a flowchart of another example method for analyzing word usage in the content; and

FIG. 18 shows a block diagram of an example system and computing device for analyzing the content.

### DETAILED DESCRIPTION

As used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another configuration includes from the one particular value and/or to the other particular value. When values are expressed as approximations, by use of the antecedent “about,” it will be understood that the particular value forms another configuration. It will be further understood that the endpoints of each of the ranges are significant both in relation to the other endpoint, and independently of the other endpoint.

“Optional” or “optionally” means that the subsequently described event or circumstance may or may not occur, and that the description includes cases where said event or circumstance occurs and cases where it does not.

Throughout the description and claims of this specification, the word “comprise” and variations of the word, such as “comprising” and “comprises,” means “including but not limited to,” and is not intended to exclude other components, integers or steps. “Exemplary” means “an example of” and is not intended to convey an indication of a preferred or ideal configuration. “Such as” is not used in a restrictive sense, but for explanatory purposes.

It is understood that when combinations, subsets, interactions, groups, etc. of components are described that, while specific reference of each various individual and collective combinations and permutations of these may not be explicitly described, each is specifically contemplated and described herein. This applies to all parts of this application including, but not limited to, steps in described methods. Thus, if there are a variety of additional steps that may be performed it is understood that each of these additional steps may be performed with any specific configuration or combination of configurations of the described methods.

As will be appreciated by one skilled in the art, hardware, software, or a combination of software and hardware may be implemented. Furthermore, a computer program product on a computer-readable storage medium (e.g., non-transitory) having processor-executable instructions (e.g., computer software) embodied in the storage medium. Any suitable computer-readable storage medium may be utilized including hard disks, CD-ROMs, optical storage devices, magnetic storage devices, memresistors, Non-Volatile Random Access Memory (NVRAM), flash memory, or a combination thereof.

Throughout this application reference is made to block diagrams and flowcharts. It will be understood that each block of the block diagrams and flowcharts, and combinations of blocks in the block diagrams and flowcharts, respectively, may be implemented by processor-executable instructions. These processor-executable instructions may be loaded onto a general purpose computer, special purpose computer, or other programmable data processing apparatus to produce a machine, such that the processor-executable instructions which execute on the computer or other programmable data processing apparatus create a device for implementing the functions specified in the flowchart block or blocks.

These processor-executable instructions may also be stored in a computer-readable memory that may direct a computer or other programmable data processing apparatus to function in a particular manner, such that the processor-executable instructions stored in the computer-readable memory produce an article of manufacture including processor-executable instructions for implementing the function specified in the flowchart block or blocks. The processor-executable instructions may also be loaded onto a computer or other programmable data processing apparatus to cause a series of operational steps to be performed on the computer or other programmable apparatus to produce a computer-implemented process such that the processor-executable instructions that execute on the computer or other programmable apparatus provide steps for implementing the functions specified in the flowchart block or blocks.

Accordingly, blocks of the block diagrams and flowcharts support combinations of devices for performing the specified functions, combinations of steps for performing the specified functions and program instruction means for performing the specified functions. It will also be understood that each block of the block diagrams and flowcharts, and combinations of blocks in the block diagrams and flowcharts, may be implemented by special purpose hardware-based computer systems that perform the specified functions or steps, or combinations of special purpose hardware and computer instructions.

“Content,” as the phrase is used herein, may also be referred to as “content items,” “content data,” “content information,” “content asset,” or simply “data” or “information”. Content may be any information or data that may be licensed to one or more individuals (or other entities, such as business or group). Content may be electronic representations of video, audio, text and/or graphics, which may be but is not limited to electronic representations of videos, movies, or other multimedia, which may be but is not limited to data files adhering to Moving Pictures Experts Group (MPEG), MPEG2, MPEG4 UHD, HDR, 4k, Adobe® Flash® Video (.FLV) format or some other video file format whether such format is presently known or developed in the future. The content described herein may be electronic representations of music, spoken words, or other audio, which may be but is not limited to data files adhering to the MPEG-1 Audio Layer 3 (.MP3) format, Adobe®, CableLabs 1.0, 1.1, 3.0, AVC, HEVC, H.264, Nielsen watermarks, V-chip data and Secondary Audio Programs (SAP). Sound Document (.ASND) format or some other format configured to store electronic audio whether such format is presently known or developed in the future. In some cases, content may be data files adhering to the following formats: Portable Document Format (.PDF), Electronic Publication (.EPUB) format created by the International Digital Publishing Forum (IDPF), JPEG (.JPG) format, Portable Network Graphics (.PNG) format, dynamic ad insertion data (.csv), Adobe® Photoshop® (.PSD) format or some other format for electronically storing text, graphics and/or other information whether such format is presently known or developed in the future. Content may be any combination of the above-described formats.

This detailed description may refer to a given entity performing some action. It should be understood that this language may in some cases mean that a system (e.g., a computer) owned and/or controlled by the given entity is actually performing the action.

Methods, systems and apparatuses are described herein for the analyzing content (e.g., live streaming content, streaming content, stored content, or video-on-demand (VOD) content). The methods, systems, and apparatuses described herein may be employed to provide a data service (e.g., such as by tracking popular topics and calculating keywords) that can be augmented to any content platforms (e.g., VOD platforms) and provide users with relevant (e.g. curated) menus of video content based on the particular user's preference(s) (e.g., topics, keywords, channels or content providers of interest, and/or time intervals).

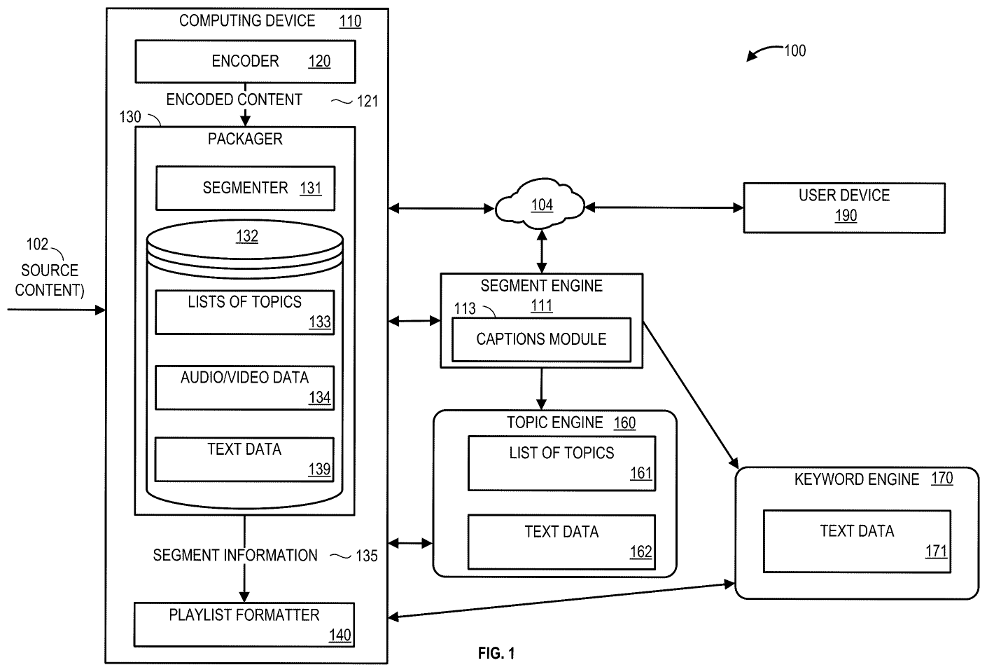

FIG. 1 shows an example system 100 for analyzing content. For example, the system 100 may be configured to analyze text (e.g., closed-caption data, detected text) located within, determined from, and/or associated with the content. The text may include any timed/synchronized display of alphanumeric and/or symbolic characters during output of content (e.g., audio and/or video) for purposes of accessibility (e.g., closed-captioning), translation (e.g., subtitles), and/or any other purpose. For example, text associated with the content may include closed-captioning data, text detected within the content, dialogue provided as text for the content, summaries of the content, descriptions of the content, third-party descriptions of the content, social media descriptions of the content, and the like. The system 100 may be configured to operate as one or more of a content delivery network, a data network, a content distribution network, a combination thereof, and/or the like. The system 100 may include a computing device 110 in communication with a plurality of other devices via a network 104. The network 104 may be an optical fiber network, a coaxial cable network, a hybrid fiber-coaxial network, a wireless network, a satellite system, a direct broadcast system, an Ethernet network, a high-definition multimedia interface network, a Universal Serial Bus (USB) network, or any combination thereof. Data may be sent on the network 104 via a variety of transmission paths, including wireless paths (e.g., satellite paths, Wi-Fi paths, cellular paths, etc.) and terrestrial paths (e.g., wired paths, a direct feed source via a direct line, etc.).

The computing device 110 may be an origin device (e.g., a content origin and/or content source) comprising a server, an encoder, a decoder, a packager, a combination thereof, and/or the like. The computing device 110 may generate and/or output portions of content, such as segments or fragments of encoded content (e.g., content segments). For example, the computing device 110 may convert raw versions of content (e.g., broadcast content) into compressed or otherwise more “consumable” versions suitable for playback/output by user devices, media devices, and other consumer-level computing devices. “Consumable” versions of content—or portions thereof—generated and/or output by an origin computing device may include, for example, data files adhering to H.264/MPEG-AVC, H.265/MPEG-HEVC, H.266/MPEG-VVC, MPEG-5 EVC, MPEG-5 LCEVC, AV1, MPEG2, MPEG, MPEG4 UHD, SDR, HDR, 4k, Adobe® Flash® Video (.FLV), ITU-T H.261, ITU-T H.262 (MPEG-2 video), ITU-T H.263, ITU-T H.264 (MPEG-4 AVC), ITU-T H.265 (MPEG HEVC), ITU-T H.266 (MPEG VVC) or any other video file format, whether such format is presently known or developed in the future. While the computing device 110 is shown as a single device, this is for example purposes only as it is to be understood that the computing device 110 may include a plurality of servers and/or a plurality devices that operate as a system to generate and/or output portions of content, convert raw versions of content (e.g., broadcast content) into compressed or otherwise more “consumable” versions, and/or analyze the content to evaluate the text associated with the content.

The system 100 may include a user device 190. The user device 190 may be a form of computing device. The user device 190 may comprise a content/media player, a set-top box, television, a desktop computer, a laptop computer, a client device, a smart device, a mobile device (e.g., a smart phone, a tablet device, etc.), a caching device (e.g., an edge cache, a mid-tier cache, a cloud cache), a combination thereof, and/or the like. The computing device 110 and the user device 190 may communicate via the network 104. The user device 190 may receive portions of requested content items (e.g., streams, segments, fragments, etc.) and/or information associated with the analysis of the content from the computing device 110. The user device 190 may send requests for portions of content and/or for analysis of the content of one or more content channels directly to the computing device 110 or via one or more intermediary computing devices (not shown), such as caching devices, routing devices, etc. While FIG. 1 shows a single user device 190, this is for example purposes only, and it is to be understood that the system 100 may include a plurality of user devices that function similarly to the user device 190.

The computing device 110 may include a plurality of modules/components, such as an encoder 120, a packager 130, and/or a playlist formatter 140, each of which may correspond to hardware, software (e.g., instructions executable by one or more processors of the computing device 110), or a combination thereof. The encoder 120 may perform bitrate conversion, coder/decoder (CODEC) conversion, frame size conversion, etc. For example, the computing device 110 may receive a plurality of source content items 102 associated with a plurality of content channels, and the encoder 120 may encode each of the source content items 102 to generate one or more encoded content items 121. The source content items 102 may be live streams of content (e.g., a linear content stream) or a video-on-demand (VOD) content. The computing device 110 may receive the source content items 102 from an external source (e.g., a content channel, a stream capture source, a data storage device, a media server, etc.). The computing device 110 may receive the source content items 102 via a wired or wireless network connection, such as the network 104 or another network (not shown). Although a single source content item 102 is shown in FIG. 1, the computing device 110 may receive any number of source content items 102 for any number of content items and for any number of content channels.

The encoder 120 may generate a plurality of encoded content items 121. Each encoded content item 121 may correspond to a particular adaptive bitrate (ABR) representation of content received via the source content item 102. For example, the plurality of encoded content items 121 may differ from one other with respect to an audio bitrate(s), a number of audio channels, an audio CODEC(s), a video bitrate(s), a video frame size(s), a video CODEC(s), a combination thereof, and/or the like. The encoder 120 may encode the source content items 102 such that key frames (e.g., intra-coded frames (I-frames)) in the plurality of encoded content items 121 occur at corresponding times as in the source content items 102. That is, each of the plurality of encoded content items 121 derived from a single source of content may be “key frame aligned” to enable seamless switching between different ABR representations by a destination device (e.g., the user device 190).

The packager 130 may include a segmenter 131 and a data storage device 132. The data storage device 132 may be a component of the packager 130, as shown in FIG. 1, or it may be a separate device/entity within the system 100 (e.g., a cache device, data storage repository, database, etc.) in communication with the packager 130. The segmenter 131 may divide a set of ABR representations of content items (e.g., the plurality encoded content items 121) into content segments. For example, the segmenter 131 may receive a target segment duration, such as a quantity of milliseconds, seconds, minutes, etc. The target segment duration may be received via user input (e.g., at the user device 190 or a user profile); it may be determined via a configuration file at the computing device 110 and/or the user device 190; it may be determined based on properties of the associated source content items 102; it may be received via the computing device 110; it may be a combination thereof, and/or the like. For example, if the target segment duration is two seconds, the segmenter 131 may segment (e.g., separate, divide, etc.) the plurality of encoded content items 121 into a plurality of content segments (e.g., at key frame boundaries). The content segments may comprise a set duration, such as two seconds, depending on a format of the content segments.

The timing data may comprise or indicate a start position/start time of a particular segment and an end position/end time of the particular segment in the source content items 102. For example, the timing data for a particular segment may comprise presentation timestamp (PTS) values that relate a time that the particular segment was encoded and/or transcoded (e.g., by the encoder 120) to a beginning of the particular content item. The PTS values for a particular segment may ensure that underlying audio/video data 134 (e.g., audio and video frames) for the segment is synchronized.

The source content items 102 may include text (e.g., detected text, closed-captioning data/subtitle content data) for or associated with the content. The text may be encoded into the plurality of encoded content items 121 by the encoder 120. Each of the content segments generated by the segmenter 131 may include corresponding text. The text may be part of the respective content segments or separately stored in the text data 139 portion of the data storage device 132. For example, the text may include closed-captioning data adhering to the CEA-608/EIA-708 closed-captions format. For example, the text may enable a decoder (e.g., at the user device 190) to decode a particular content segment and present the corresponding video content and audio content with the text associated with video content and audio content embedded therein. The text for a particular content segment may include caption cues indicative of a beginning time code and an ending time code of for each portion of the text associated with the particular content segment, such as one or more words, one or more sentences, a description, and/or any other information that may be conveyed via text. The timing data and the caption cues for a particular content segment may be used to ensure that text associated with the content segment is aligned with audio/video data 134 (e.g., encoded video content and/or audio content) during playback (e.g., at the user device 190).

The segmenter 131 may generate and/or send segment information 135 to a playlist formatter 140. The segment information 135 for a particular segment may refer to (e.g., be indicative of a storage location of) the underlying audio/video data 134 (e.g., audio and video frames) and/or the underlying text associated with the particular segment of the content. The playlist formatter 140 may generate playlists based on the segment information 135 received from the packager 130. The playlists may comprise manifest files, such as MPEG-DASH media presentation description (MPD) files for MPEG-DASH and/or HLS content. The playlist formatter 140 may generate one or more playlists (e.g., manifests).

The system 100 may include a segment engine 111 (e.g., a slice engine). The segment engine 111 may be part of the computing device 110 or may be a separate computing device in communication with computing device 110 via a network (e.g., the network 104 or another network (not shown)). The segment engine 111 may include a single computing device, or it may comprise a system/network of computing devices. The segment engine 111 may include a captions module 113. The captions module 113 may be configured to receive the plurality of content segments for a source content item 102 from the computing device 110 (e.g., from the segmenter 131 of the packager 130). The captions module 113 may be configured to parse each of the plurality of content segments and identify and/or retrieve the text associated with (e.g., included with) each respective content segment of the plurality of content segments. In another example, the captions module 113 may receive the text for the plurality of content segments of the source content item 102 from the text data portion 139 of the data storage device 132. The segment engine 111 may be able to provide the text parsed from the plurality of content segments to other portions of the system 100.

The system 100 may include a topic engine 160. The topic engine 160 may be part of the computing device 110 or may be a separate computing device in communication with computing device 110 via a network (e.g., the network 104 or another network (not shown)). The topic engine 160 may include a single computing device, or it may comprise a system/network of computing devices.

The topic engine 160 may be configured to receive text and store the text into a text data storage device 162. For example, the topic engine 160 may receive the text from one or more of the segment engine 111 or the computing device 110 via the network 104 or another network (not shown).

The topic engine 160 may receive or otherwise identify one or more topics for comparison. For example, the topic engine 160 may receive a plurality of topics from one or more third-party sources (e.g., a GOOGLE trends application programming interface (API), a TWITTER API, or another third-party source) via the network 104 or another network (not shown). For example, the topic engine 160 may determine one or more topics. The one or more topics may be associated with trending or otherwise current events. For example, the one or more topics may include or be based on the most searched queries over a period of time (e.g., the prior 24 hours, 2 days, 3 days, a week, a month, or any other time period between and including 1 hour to 1 year), the popular hashtags on one or more social media websites for a period of time, or based on a combination of the most searched queries and the most popular hashtags for a period of time.

The topic engine 160 may analyze the text associated with the content (e.g., the content segments of the content) for a plurality of content channels in view of the one or more topics to determine frequency value information for each of the one or more topics for each of the one or more content channels for a time period of analysis (e.g., the prior 24 hours, 2 days, 3 days, a week, a month, or any other time period between and including 1 hour to 1 year). The topic engine 160 may generate an output of the analysis to the user device 190 via the network 104 or another network (not shown).

The system 100 may include a keyword engine 170. The keyword engine 170 may be part of the computing device 110 or may be a separate computing device in communication with computing device 110 via a network (e.g., the network 104 or another network (not shown)). The keyword engine 160 may include a single computing device, or it may comprise a system/network of computing devices.

The keyword engine 170 may receive the text and store the text into a text data storage device 171. For example, the keyword engine 171 may receive the text from one or more of the segment engine 111 or the computing device 110 via the network 104 or another network (not shown).

The keyword engine 170 may analyze the text associated with the content (e.g., the content segments of the content) for a plurality of content channels to determine frequency value information for the words and/or phrases in the text of the one or more content channels for a time period of analysis (e.g., the prior 24 hours, 2 days, 3 days, a week, a month, or any other time period between and including 1 hour to 1 year). The keyword engine 170 may generate an output of the analysis to the user device 190 via the network 104 or another network (not shown).

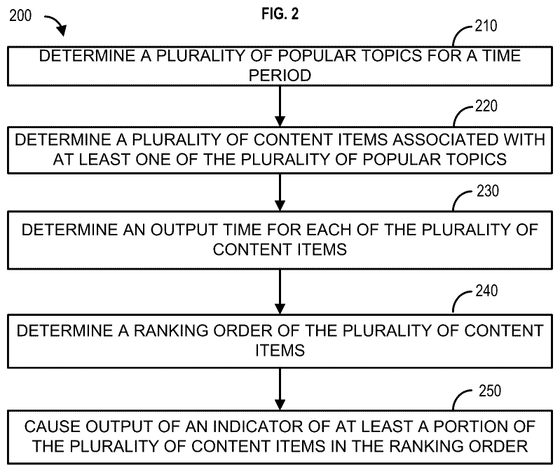

FIG. 2 shows a flowchart of an example method 200 for determining content items related to popular topics. For example, the determination may be made by a computing device (e.g., the computing device 110 or the topic engine 160). At 210, a plurality of popular topics for a time period may be determined. For example, the computing device 110 or the topic engine 160 may determine the plurality of topics. For example, the period of time may be a preset period of time or an adjustable period of time. For example, the period of time may be adjusted via a user input received by the computing device 110. For example, the period of time may be the prior 24 hours, 2 days, 3 days, a week, a month, or any other time period between and including 1 hour to 1 year.

For example, each of the plurality of topics may be one or more words or phrases that define a topic of interest. For example, the topics may include or be based on the most received search queries over the period of time. For example, the topics may include or be based on the popular (e.g., most used) hashtags on one or more social media websites for the period of time. For example, the topics may be a combination of or be based on a combination of the most searched queries and the most popular hashtags for the period of time.

For example, the topics may be internally determined or received from a third-party source (e.g., a GOOGLE trends application programming interface (API), a TWITTER API, or another third-party source). For example, the computing device (e.g., the computing device 110 and/or topic engine 160) may send or otherwise transmit a request to the third party source requesting a group or listing of topics for the period of time. For example, a group or listing of topics (e.g., popular topics or trending topics) for the period of time may be received from the third-party source via a wired or wireless network connection, such as the network 104 or another network (not shown) by the computing device (e.g., the computing device 110 and/or the topic engine 160) in response to the request. For example, the topics may be generated and/or provided by one or more users via user input and received via a wired or wireless network connection, such as the network 104 or another network (not shown) from a user device 190. The plurality of popular topics may be stored in a list of topics table 161 or a data storage device.

At 220, a plurality of content items associated with at least one of the plurality of popular topics may be determined. For example, the plurality of content items may include the content items 102. For example, the computing device 110 or the topic engine 160 may determine the plurality of content items 102 associated with at least one of the plurality of popular topics. For example, the content items 102 may comprise video content, audio content, web-based content, streaming content, movies, shows/programs, sporting events, etc.).

For example, the computing device may receive the plurality of content items 102. The plurality of content items 102 may contain audio content, video content, or a combination of audio and video content. For example, each of the plurality of content items 102 may be live content (e.g., a linear content stream) or video-on-demand (VOD) content. For example, the computing device 110 may receive each of the plurality of content items 102 from an external content source (e.g., a stream capture source, a data storage device, a media server, a content channel, etc.) via a wired or wireless network connection, such as the network 104 or another network (not shown). For example, each of the plurality of content items 102 may be from or associated with one or more content channels (e.g., Channel 1, Channel 2, Channel 3, etc.). For example, the computing device 110 may receive more than one of the plurality of content items 102 concurrently.

For example, the computing device may determine the plurality of content items associated with at least one of the plurality of popular topics based on detected text associated with each particular content item of the plurality of content items. For example, the computing device may determine a content item is associated with a particular topic if the detected text of that content item matches or substantially matches the particular topic. For example, detected text may substantially match the particular topic if a portion of the text in the detected text is a derivative of the popular topic word. For example, the detected text may comprise the closed-captioning data, dialogue provided as text, summaries, descriptions, third-party descriptions, social media descriptions, and the like for the content item or portion (e.g., segment) of the content item. For example, the computing device may compare each item of detected text (e.g., words, phrases, etc.) to each of the plurality of popular topics to determine if a match or substantial match exists. Based on a match existing, the computing device may determine that the content item 102 or portion (segment) of the content item is associated with the particular topic of the plurality of popular topics.

For example, the computing device (e.g., the computing device 110 and/or captions module 113 of the segment engine 111) may determine the detected text associated with each of the content items 102 (e.g., each of the segments of the content item). For example, each content segment of a particular content item 102 may include detected text (e.g., embedded text or closed-captioning data in the CEA-608 or CEA-708 format) for that content segment or a subsequent content segment (e.g., the next sequential content segment). The text may include a text string of words associated with the content segment (e.g., the dialogue occurring during the content segment or a subsequent content segment, a description of a scene occurring during that content segment or a subsequent content segment, a description of audio (e.g., music, sounds) occurring during that content segment or a subsequent content segment, etc.). The captions module 113 of the segment engine 111 may parse the content segment and identify and/or retrieve the detected text associated with (e.g., included with) the content item.

For example, the computing device (e.g., the captions module 113) may normalize one or more of the words within the detected text for the content item 102 (e.g., for each content segment of the content item). For example, in normalizing the one or more words, the captions module 113 may modify any plural form of a word into a singular form of that word, may modify any possessive form of a word into a non-possessive form of the word, may modify all verbs within the text from past or future tense to present tense, may remove all articles (e.g., a, an, the) from the text, etc.

The plurality of content items 102 may comprise an entire content item and/or portions of a content item. For example, the computing device (e.g., a segmenter 131 of the computing device 110) may separate each of the plurality of content items 102 into a plurality of content segments. Each content segment for each of the plurality of content items 102 may include a portion of the particular content item 102. For example, the segmenter 131 of the packager 130 may separate each of the plurality of content items 102 into sequential content segments in chronological order of the respective content item 102. The segmenter 131 may assign a unique content segment identifier to each content segment of the plurality of content segments created. For example, the unique content segment identifier may be or include a segment number. For example, the unique content segment identifier may be a full or partial URL address, another form of counter variable, or another unique identifier.

For example, the content segments may have a predetermined data size or time duration. For example, the segmenter 131 may have a target segment duration of two thousand milliseconds (or another desired length of duration, such as any time period between 0-60 seconds). For example, if the target segment duration is two seconds, the segmenter 131 may process each of the plurality of content items 102 and break each content item 102 into segments at key frame boundaries approximately two seconds apart. Further, if the source content item 102 includes separate video and audio content, the segmenter 131 may generate the content segments such that the separate content segments of video and audio content are timecode aligned.

At 230, an output time for each of the plurality of content items may be determined. For example, the output times may be determined by the computing device 110. For example, the output time may comprise the time (e.g., time and date) that each particular content item of the plurality of content items was aired or played. For example, the output time for each content item (or segment of content item) may be determined from the metadata for that particular content item (or segment of the content item). For example, the output time may be determined from a database of display times for the plurality of content items. For example, for content items that have more than one display time, the display time may be considered to be the most recent time the content item was aired or played or the least recent time the content item was aired or played.

At 240, a ranking order of the plurality of content items (or one or more segments of each of the plurality of content items) may be determined. For example, the ranking may be determined by the computing device 110. For example, the ranking order may be based on the output time for each of the plurality of content items. For example, the ranking order may be from most recent output time to least recent output time. For example, the content item 102 (or segment of the content item) with most recent output time may be the highest ranking content item (or segment), the content item 102 (or segment of the content item) with least recent output time may be the lowest ranking content item (or segment) and the ranking for output times for the remaining of the plurality of the content items 102 (or segments of content items) between the most recent and least recent output times may be ordered in output time order (e.g., chronological order) from most recent to least recent.

For example, each content item 102 (or segment) may be weighted or given a weighted score based on the particular content item's (or segment's) output time. For example, the weight or weighted score may be greater for output times that are more recent and less for output times that are less recent. Accordingly, content items 102 (or segments) having more recent output times and being associated with at least one of the plurality of popular topics may receive a greater weight or weighted score. For example, the ranking order may be determined based at least on the weight or weighted score for each of the content items 102 (or segments).

For example, the plurality of content items may be further sorted from one another based on the particular topic that the content item 102 (or segment of the content item) is associated with (e.g., has detected text that matches or substantially matches the particular topic of the plurality of popular topics). For example, the computing device 110 may determine a first portion of the plurality of content items associated with a first topic of the plurality of popular topics. The computing device 110 may determine a ranking order for the first portion of the plurality of content items. The ranking order may be determined based on the output time for those content items 102 in the first portion, as discussed above. The computing device 110 may then repeat the process for the other remaining topics of the plurality of popular topics to create a ranking order of content items 102 (or segments) for each topic of the plurality of popular topics.

For example, the plurality of content items may be further sorted from one another based on the particular content source (e.g., channel, website, streaming content provider) that the content item 102 (or segment of the content item) is associated with (e.g., was aired or displayed). For example, the computing device 110 may determine a first portion of the plurality of content items associated with a first content source. The computing device 110 may determine a ranking order for the first portion of the plurality of content items. The ranking order may be determined based on the output time for those content items 102 in the first portion, as discussed above. The computing device 110 may then repeat the process for the other content sources to create a ranking order of content items 102 (or segments) for each content source.

At 250, one or more indicators (e.g., a plurality of indicators) of at least a portion of the plurality of content items 102 (or segments of the content items) may be output or caused to be output. For example, the plurality of indicators may be output or caused to be output by the computing device 110. For example, outputting or causing output of the indicators of the portion of the content item may comprise the content segment associated with at least one of the plurality of popular topics.

For example, due to size, space or other limitations or preferences, not all of the plurality of content items 102 may be indicated in the ranking order. For example, indicators for only the highest ranking 10, 20, 30, 40, etc. of the plurality of content items 102 (or segments) may be output or caused to be output. For example, the size, space or other limitations or preferences may further be applied to rankings broken down by each topic of the plurality of popular topics and/or each content source providing the particular content items 102.

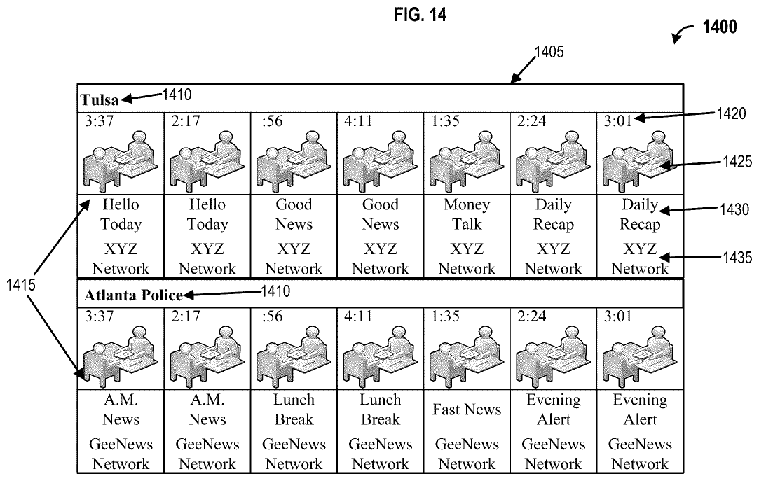

For example, the indicator may comprise at least one of: a title of the content item 102, an image associated with the content item 102, a content source (e.g., a channel name, channel number, website, or streaming site) that provided the content item 102, the popular topic the content item or portion of the content item is associated with, or a run time for the content time or portion of the content item 102. For example, the image may comprise a key frame of the content item and/or the segment of the particular content item. For example, the image may provide a link to an output of the content item or portion of the content item 102. For example, the portion of the content item 102 may comprise the segment of the content item associated with at least one of the popular topics. For example, the portion of the content item 102 may further comprise one or more additional segments chronologically positioned before and/or after the segment associated with at least one of the popular topics. For example, the indicator may be the same or similar to the thumbnails 1415 of FIG. 14.

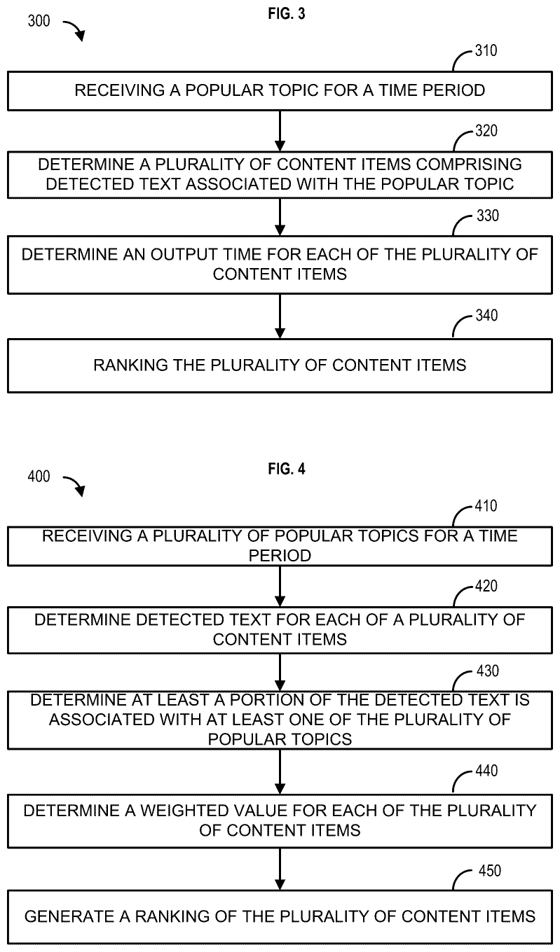

FIG. 3 shows a flowchart of an example method 300 for determining content items related to popular topics. For example, the determination may be made by a computing device (e.g., the computing device 110 or the topic engine 160). At 310, a popular topic for a time period may be received. For example, the computing device 110 or the topic engine 160 may receive the popular topic from the user device 190 or from a third party service provider. For example, the period of time may be a preset period of time or an adjustable period of time. For example, the period of time may be adjusted via a user input received from the user device 190 by the computing device 110. For example, the period of time may be the prior 24 hours, 2 days, 3 days, a week, a month, or any other time period between and including 1 hour to 1 year.

For example, the popular topic may be one or more words or phrases that define a topic of interest. For example, the popular topic may include or be based on one of the most received search queries over the period of time. For example, the popular topic may include or be based on one of the popular (e.g., most used) hashtags on one or more social media websites for the period of time.

For example, the popular topic may be internally determined or received from a third-party source (e.g., a GOOGLE trends application programming interface (API), a TWITTER API, or another third-party source). For example, the computing device (e.g., the computing device 110 and/or topic engine 160) may send or otherwise transmit a request to the third party source requesting one or more popular topics for the period of time. For example, the one or more popular topics (e.g., popular topics or trending topics) for the period of time may be received from the third-party source via a wired or wireless network connection, such as the network 104 or another network (not shown) by the computing device (e.g., the computing device 110 and/or the topic engine 160) in response to the request. For example, the popular topic may be generated and/or provided by one or more users via user input at the user device 190 and received via a wired or wireless network connection, such as the network 104 or another network (not shown).

At 320, a plurality of content items associated with the popular topic may be determined. For example, the plurality of content items may include the content items 102. For example, the computing device 110 or the topic engine 160 may determine the plurality of content items 102 associated with the popular topic. For example, the content items 102 may comprise video content, audio content, web-based content, streaming content, movies, shows/programs, sporting events, concerts, etc.).

For example, the computing device may receive the plurality of content items 102. The plurality of content items 102 may contain audio content, video content, or a combination of audio and video content. For example, each of the plurality of content items 102 may be live content (e.g., a linear content stream) or video-on-demand (VOD) content. For example, the computing device 110 may receive each of the plurality of content items 102 from an external content source (e.g., a stream capture source, a data storage device, a media server, a content channel, etc.) via a wired or wireless network connection, such as the network 104 or another network (not shown). For example, each of the plurality of content items 102 may be from or associated with one or more content channels (e.g., Channel 1, Channel 2, Channel 3, etc.). For example, the computing device 110 may receive more than one of the plurality of content items 102 concurrently.

For example, the computing device 110 may determine the plurality of content items associated with the popular topic based on detected text associated with each particular content item of the plurality of content items. For example, the computing device 110 may determine a content item is associated with the popular topic if the detected text of that content item matches or substantially matches the popular topic. For example, detected text may substantially match the popular topic if a portion of the text in the detected text is a derivative of the popular topic word or phrase. For example, the detected text may comprise closed-captioning data, dialogue provided as text, summaries, descriptions, third-party descriptions, social media descriptions, and the like for the content item or portion (e.g., segment) of the content item 102. For example, the computing device 110 may compare each item of detected text (e.g., words, phrases, etc.) to the popular topic to determine if a match or substantial match exists. Based on a match existing, the computing device 110 may determine that the content item 102 or portion (segment) of the content item is associated with the popular topic.

For example, the computing device (e.g., the computing device 110 and/or captions module 113 of the segment engine 111) may determine the detected text associated with each of the content items 102 (e.g., each of the segments of the content item). For example, each content segment of a particular content item 102 may include detected text (e.g., embedded text or closed-captioning data in the CEA-608 or CEA-708 format) for that content segment or a subsequent content segment (e.g., the next sequential content segment). The text may include a text string of words associated with the content segment (e.g., the dialogue occurring during the content segment or a subsequent content segment, a description of a scene occurring during that content segment or a subsequent content segment, a description of audio (e.g., music, sounds) occurring during that content segment or a subsequent content segment, etc.). The captions module 113 of the segment engine 111 may parse the content segment and identify and/or retrieve the detected text associated with (e.g., included with) the content item.

For example, the computing device (e.g., the captions module 113) may normalize one or more of the words within the detected text for the content item 102 (e.g., for each content segment of the content item). For example, in normalizing the one or more words, the captions module 113 may modify any plural form of a word into a singular form of that word, may modify any possessive form of a word into a non-possessive form of the word, may modify all verbs within the text from past or future tense to present tense, may remove all articles (e.g., a, an, the) from the text, etc.

The plurality of content items 102 may comprise an entire content item and/or portions of a content item 102. For example, the computing device (e.g., a segmenter 131 of the computing device 110) may separate each of the plurality of content items 102 into a plurality of content segments. Each content segment for each of the plurality of content items 102 may include a portion of the particular content item 102. For example, the segmenter 131 of the packager 130 may separate each of the plurality of content items 102 into sequential content segments in chronological order of the respective content item 102. The segmenter 131 may assign a unique content segment identifier to each content segment of the plurality of content segments created.

For example, the content segments may have a predetermined data size or time duration. For example, if the target segment duration is two seconds, the segmenter 131 may process each of the plurality of content items 102 and break each content item 102 into segments at key frame boundaries approximately two seconds apart.

At 330, an output time for each of the plurality of content items may be determined. For example, the output times may be determined by the computing device 110. For example, the output time may comprise the time (e.g., time and date) that each particular content item of the plurality of content items was aired or played. For example, the output time for each content item 102 (or segment of content item) may be determined from the metadata for that particular content item 102 (or segment of the content item). For example, the output time may be determined from a database of display times for the plurality of content items 102. For example, for content items 102 that have more than one display time, the display time may be considered to be the most recent time the content item was aired or played or the least recent time the content item was aired or played.

At 340, the plurality of content items (or one or more segments of each of the plurality of content items) may be ranked. For example, ranking the content items 102 may be conducted by the computing device 110. For example, the plurality of content items 102 may be ranked based on the output time for each of the plurality of content items. For example, the plurality of content items 102 (or segments) may be ranked from most recent output time to least recent output time. For example, the content item 102 (or segment of the content item) with most recent output time may be the highest ranking content item (or segment), the content item 102 (or segment of the content item) with least recent output time may be the lowest ranking content item (or segment) and the ranking for output times for the remaining of the plurality of the content items 102 (or segments of content items) between the most recent and least recent output times may be ordered in output time order (e.g., chronological order) from most recent to least recent.

For example, each content item 102 (or segment) may be weighted or given a weighted score based on the particular content item's (or segment's) output time. For example, the weight or weighted score may be greater for output times that are more recent and less for output times that are less recent. Accordingly, content items 102 (or segments) having more recent output times and being associated with the popular topic may receive a greater weight or weighted score. For example, ranking the plurality of content items 102 (or segments) may be based at least on the weight or weighted score for each of the content items 102 (or segments).

For example, the plurality of content items may be further sorted from one another based on the particular content source (e.g., channel, website, streaming content provider) that the content item 102 (or segment of the content item) is associated with (e.g., was aired or displayed). For example, the computing device 110 may determine a first portion of the plurality of content items associated with a first content source. The computing device 110 may determine a ranking order for the first portion of the plurality of content items 102. The ranking order may be determined based on the output time for those content items 102 in the first portion, as discussed above. The computing device 110 may then repeat the process for the other content sources to create a ranking order of content items 102 (or segments) for each content source.

For example, the computing device 110 may receive a second popular topic for the time period. For example, the second popular topic may be received in substantially the same manner as described above at 310 with regard to the popular topic. For example, the computing device 110 may determine a second plurality of content items 102 comprising second detected text that is associated with the second popular topic, in substantially the same manner as described above at 320 with regard to the plurality of content items 102 and the popular topic. For example, the computing device 110 may rank the second plurality of content items 102 based on the output time for each of the second plurality of content items 102, in substantially the same manner as described above at 330-340 with regard to the plurality of content items 102.

For example, the computing device 110 may further output or cause to be output a plurality of indicators of at least a portion of the plurality of content items 102 (or segments of the content items). For example, outputting or causing output of the indicators of a portion of the content items 102 may comprise the content segment of each content item 102 associated with the popular topic.

For example, due to size, space or other limitations or preferences, not all of the plurality of content items 102 may be indicated in the ranking order. For example, indicators for only the highest ranking 10, 20, 30, 40, etc. of the plurality of content items 102 (or segments) may be output or caused to be output. For example, the size, space or other limitations or preferences may further be applied to rankings broken down by each content source providing the particular content items 102.

For example, the indicator may comprise at least one of: a title of the content item 102, an image associated with the content item 102, a content source (e.g., a channel name, channel number, website, or streaming site) that provided the content item 102, the popular topic the content item or portion of the content item is associated with, or a run time for the content time or portion of the content item 102. For example, the image may comprise a key frame of the content item and/or the segment of the particular content item. For example, the image may provide a link to an output of the content item or portion of the content item 102. For example, the portion of the content item 102 may comprise the segment of the content item associated with the popular topic. For example, the portion of the content item 102 may further comprise one or more additional segments chronologically positioned before and/or after the segment associated with the popular topic. For example, the indicator may be the same or similar to the thumbnails 1415 of FIG. 14.

FIG. 4 shows a flowchart of an example method 400 for determining content items related to popular topics. For example, the determination may be made by a computing device (e.g., the computing device 110 or the topic engine 160). At 410, a plurality of popular topics for a time period may be received. For example, the computing device 110 or the topic engine 160 may receive the plurality of popular topics from the user device 190 or from a third party service provider. For example, the period of time may be a preset period of time or an adjustable period of time. For example, the period of time may be adjusted via a user input received from the user device 190 by the computing device 110. For example, the period of time may be the prior 24 hours, 2 days, 3 days, a week, a month, or any other time period between and including 1 hour to 1 year.

For example, one or more of the plurality of popular topics may be one or more words or phrases that define a topic of interest. For example, the plurality of popular topics may include or be based on the most received search queries over the period of time. For example, the plurality of popular topics may include or be based on the popular (e.g., most used) hashtags on one or more social media websites for the period of time.

For example, the plurality of popular topics may be internally determined or received from a third-party source (e.g., a GOOGLE trends application programming interface (API), a TWITTER API, or another third-party source). For example, the computing device (e.g., the computing device 110 and/or topic engine 160) may send or otherwise transmit a request to the third party source requesting one or more popular topics for the period of time. For example, the one or more popular topics (e.g., popular topics or trending topics) for the period of time may be received from the third-party source via a wired or wireless network connection, such as the network 104 or another network (not shown) by the computing device (e.g., the computing device 110 and/or the topic engine 160) in response to the request. For example, the plurality of popular topics may be generated and/or provided by one or more users via user input at the user device 190 and received via a wired or wireless network connection, such as the network 104 or another network (not shown).

At 420, detected text for each of a plurality of content items may be determined. For example, the plurality of content items may include the content items 102. For example, the computing device 110 or the captions module 113 may determine the detected text for the plurality of content items 102. For example, the content items 102 may comprise video content, audio content, web-based content, streaming content, movies, shows/programs, sporting events, concerts, etc.).

For example, the computing device may receive the plurality of content items 102. The plurality of content items 102 may contain audio content, video content, or a combination of audio and video content. For example, each of the plurality of content items 102 may be live content (e.g., a linear content stream) or video-on-demand (VOD) content. For example, the computing device 110 may receive each of the plurality of content items 102 from an external content source (e.g., a stream capture source, a data storage device, a media server, a content channel, etc.) via a wired or wireless network connection, such as the network 104 or another network (not shown). For example, each of the plurality of content items 102 may be from or associated with one or more content channels (e.g., Channel 1, Channel 2, Channel 3, etc.). For example, the computing device 110 may receive more than one of the plurality of content items 102 concurrently.

The plurality of content items 102 may comprise an entire content item and/or portions of a content item 102 (e.g., a content segment). For example, the computing device (e.g., a segmenter 131 of the computing device 110) may separate each of the plurality of content items 102 into a plurality of content segments. Each content segment for each of the plurality of content items 102 may include a portion of the particular content item 102. For example, the segmenter 131 of the packager 130 may separate each of the plurality of content items 102 into sequential content segments in chronological order of the respective content item 102. The segmenter 131 may assign a unique content segment identifier to each content segment of the plurality of content segments created.

For example, the content segments may have a predetermined data size or time duration. For example, if the target segment duration is two seconds, the segmenter 131 may process each of the plurality of content items 102 and break each content item 102 into segments at key frame boundaries approximately two seconds apart.

For example, each of the plurality of content items 102 may include detected text. For example, the detected text may comprise closed-captioning data, dialogue provided as text, summaries, descriptions, third-party descriptions, social media descriptions, and the like for the content item or portion (e.g., segment) of the content item 102. For example, each content segment of a particular content item 102 may include detected text (e.g., embedded text or closed-captioning data in the CEA-608 or CEA-708 format) for that content segment or a subsequent content segment (e.g., the next sequential content segment). The text may include a text string of words associated with the content segment (e.g., the dialogue occurring during the content segment or a subsequent content segment, a description of a scene occurring during that content segment or a subsequent content segment, a description of audio (e.g., music, sounds) occurring during that content segment or a subsequent content segment, etc.). The captions module 113 may parse the content segment and identify and/or retrieve the detected text associated with (e.g., included with) the content item.

For example, the computing device (e.g., the captions module 113) may normalize one or more of the words within the detected text for the content item 102 (e.g., for each content segment of the content item). For example, in normalizing the one or more words, the captions module 113 may modify any plural form of a word into a singular form of that word, may modify any possessive form of a word into a non-possessive form of the word, may modify all verbs within the text from past or future tense to present tense, may remove all articles (e.g., a, an, the) from the text, etc.

At 430, at least a portion of the detected text may be determined to be associated with at least one of the plurality of popular topics. For example, the computing device 110 may determine a content item is associated with the popular topic if the detected text of that content item matches or substantially matches the popular topic. For example, detected text may substantially match the popular topic if a portion of the text in the detected text is a derivative of the popular topic word or phrase. For example, the computing device 110 may compare each item of detected text (e.g., words, phrases, etc.) to the popular topic to determine if a match or substantial match exists. Based on a match existing, the computing device 110 may determine that the content item 102 or portion (segment) of the content item is associated with the popular topic.

At 440, a weighted value for each of the plurality of content items 102 may be determined. For example, the weighted value may be determined by the computing device 110. For example, the weighted value for each of the plurality of content items 102 (or segments of the content item) may be based on a recency of an output time for each of those particular content items 102 (or segments). For example, the output time may comprise the time (e.g., time and date) that each particular content item (or segment) of the plurality of content items was aired or played. For example, the output time for each content item 102 (or segment of content item) may be determined from the metadata for that particular content item 102 (or segment of the content item). For example, the output time may be determined from a database of display times for the plurality of content items 102. For example, for content items 102 that have more than one display time, the display time may be considered to be the most recent time the content item was aired or played or the least recent time the content item was aired or played.

For example, the weighted value may be a numerical value. For example, the weighted value may be proportional to how recent the output time is for the particular content item 102 or segment. For example, greater numerical values may be allotted to content items 102 or segments that have an output time that is more recent and lesser numerical values may be allotted to content items 102 or segments that have an output time that is less recent. Accordingly, content items 102 or segments that are associated with one of the plurality of popular topics and have been output more recently will be weighted more heavily and ranked higher than content items 102 or segments that are associated with one of the plurality of popular topics and have been output less recently.

At 450, a ranking of the plurality of content items may be generated. For example, ranking the content items 102 may be conducted by the computing device 110. For example, the ranking of the plurality of content items 102 (or segments) may be based on the weighted value allotted to each of the plurality of content items 102 (or segments). For example, the plurality of content items 102 may be ranked in numerical order based on the weighted values allowed to the content items 102 or segments. For example, the ranking may be from highest to lowest numerical value. For example, the content item 102 (or segment) with the highest numerical value (e.g., highest weighted value) may be the highest ranking content item (or segment) and the content item 102 (or segment of the content item) with lowest numerical value (e.g., lowest weighted value) may be the lowest ranking content item (or segment).

For example, the plurality of content items 102 may be further sorted from one another based on the particular topic that the content item 102 (or segment) is associated with (e.g., has detected text that matches or substantially matches the particular topic of the plurality of popular topics). For example, the computing device 110 may determine a first portion of the plurality of content items associated with a first topic of the plurality of popular topics. The computing device 110 may generate a ranking for the first portion of the plurality of content items based on the weighted values for the first portion of the plurality of content items. The computing device 110 may then repeat the process for one or more of the other remaining topics of the plurality of popular topics to create a ranking order of content items 102 (or segments) for each topic of the plurality of popular topics.

For example, the plurality of content items may be further sorted from one another based on the particular content source (e.g., channel, website, streaming content provider) that the content item 102 (or segment of the content item) is associated with (e.g., was aired or displayed). For example, the computing device 110 may determine a first portion of the plurality of content items associated with a first content source. The computing device 110 may generate a ranking for the first portion of the plurality of content items 102 based on the weighted values for the first portion of the plurality of content items. The computing device 110 may then repeat the process for one or more other content sources to create a ranking order of content items 102 (or segments) for each content source.

For example, the computing device 110 may further output or cause to be output a plurality of indicators of at least a portion of the plurality of content items 102 (or segments of the content items). For example, outputting or causing output of the indicators of a portion of the content items 102 may comprise the content segment of each content item 102 associated with the popular topic. For example, the plurality of indicators may be output in order of the generated ranking of the plurality of content items 102 (or segments).

For example, due to size, space or other limitations or preferences, not all of the plurality of content items 102 may be indicated in the outputted ranking. For example, indicators for only the highest ranking 10, 20, 30, 40, etc. of the plurality of content items 102 (or segments) may be output or caused to be output. For example, the size, space or other limitations or preferences may further be applied to rankings broken down by each content source providing the particular content items 102.

For example, the indicator may comprise at least one of: a title of the content item 102, an image associated with the content item 102, a content source (e.g., a channel name, channel number, website, or streaming site) that provided the content item 102, the popular topic the content item or portion of the content item is associated with, or a run time for the content time or portion of the content item 102. For example, the image may comprise a key frame of the content item and/or the segment of the particular content item. For example, the image may provide a link to an output of the content item or portion of the content item 102. For example, the portion of the content item 102 may comprise the segment of the content item associated with the popular topic. For example, the portion of the content item 102 may further comprise one or more additional segments chronologically positioned before and/or after the segment associated with the popular topic. For example, the indicator may be the same or similar to the thumbnails 1415 of FIG. 14.

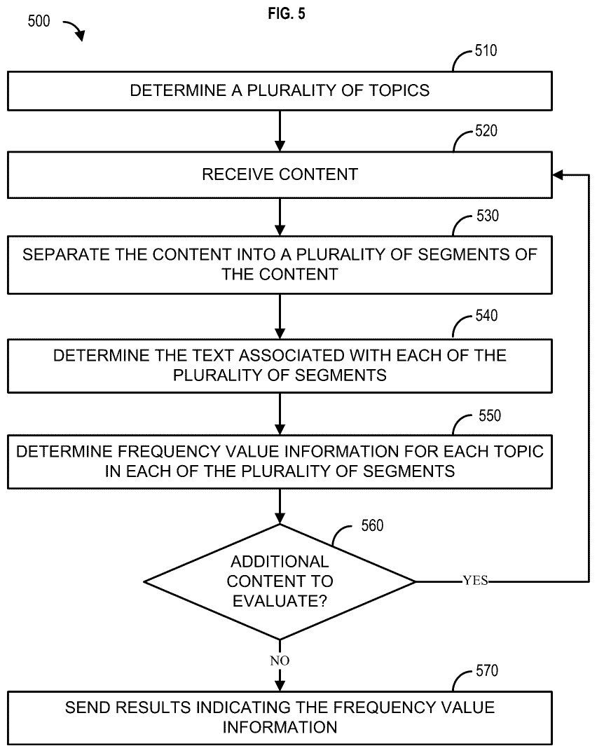

FIG. 5 shows a flowchart of an example method 500 for determining topics within content by a computing device (e.g., the computing device 110 or the topic engine 160). For example, the computing device 110 may include the topic engine 160 or may be communicably coupled to the topic engine 160.

At 510, a computing device (e.g. the computing device 110 and/or the topic engine 160) may determine a plurality of topics. For example, each of the plurality of topics may be one or more words or phrases that define a topic of interest. For example, the topics may include or be based on the most searched queries over a period of time (e.g., the prior 24 hours, 2 days, 3 days, a week, a month, or any other time period between and including 1 hour to 1 year). For example, the topics may include or be based on the popular hashtags on one or more social media websites for a period of time (e.g., the prior 24 hours, 2 days, 3 days, a week, a month, or any other time period between and including 1 hour to 1 year). For example, the topics may be a combination of or be based on a combination of the most searched queries and the most popular hashtags for a period of time (e.g., the prior 24 hours, 2 days, 3 days, a week, a month, or any other time period between and including 1 hour to 1 year). For example, the topics may be internally determined or received from a third-party source (e.g., a GOOGLE trends application programming interface (API), a TWITTER API, or another third-party source). For example, the computing device (e.g., the computing device 110 and/or topic engine 160 may send or otherwise transmit a request to the third party source requesting a group or listing of topics for the period of time. For example, a group or listing of topics (e.g., trending topics) for the period of time may be received from a third-party source via a wired or wireless network connection, such as the network 104 or another network (not shown) by the computing device (e.g., the computing device 110 and/or the topic engine 160) in response to the request. For example, the topics may be generated and/or provided by one or more users and received via a wired or wireless network connection, such as the network 104 or another network (not shown) from a user device 190. The list of topics may be stored in a list of topics table 161 or a data storage device.

At 520, the computing device (e.g., the computing device 110 and/or the topic engine 160) may receive one or more source content items 102 (e.g., a content stream). The one or more source content items 102 may contain audio content, video content, or a combination of audio and video content. For example, each of the one or more source content items 102 may be live content (e.g., a linear content stream) or video-on-demand (VOD) content. For example, the computing device 110 may receive each of the one or more source content items 102 from an external source (e.g., a stream capture source, a data storage device, a media server, etc.) via a wired or wireless network connection, such as the network 104 or another network (not shown). For example, each of the one or more source content items 102 may be from one or more content channels (e.g., Channel 1, Channel 2, Channel 3, etc.) For example, the computing device 110 may receive a plurality of the source content items 102 concurrently. The plurality of the source content items 102 may each be associated with one or more different content channels.

At 530, the computing device (e.g., a segmenter 131 of the computing device 110) may separate the source content items 102 into a plurality of content segments. Each content segment for each of the source content items 102 may include a portion of the source content items 102. For example, the segmenter 131 of the packager 130 may separate the source content items 102 into sequential content segments in chronological order of the respective source content item 102. The segmenter 131 may assign a unique content segment identifier to each content segment of the plurality of content segments created. For example, the unique content segment identifier may be or include a segment number. For example, the segmenter 131 may initiate a counter associated with the particular source content item 102 (e.g., starting the counter at 0 or 1) and increment the counter for each segment that is created from the source content item 102. In other examples, the unique content segment identifier may be a full or partial URL address, another form of counter variable, or another unique identifier.

For example, the source content items 102 may be separated into content segments having a predetermined data size or time duration. For example, the segmenter 131 may have a target segment duration of two thousand milliseconds (or another desired length of duration, such as any time period between 0-60 seconds). The target segment duration may be a preset amount, received via user input, or dynamically determined based on properties of the source content item 102 or the packager 130. For example, if the target segment duration is two seconds, the segmenter 131 may process the source content item 102 and break the source content item 102 into segments at key frame boundaries approximately two seconds apart. Further, if the source content item 102 includes separate video and audio content, the segmenter 131 may generate the content segments such that the separate content segments of video and audio content are timecode aligned.

At 540, the computing device (e.g., the computing device 110 and/or captions module 113 of the segment engine 111) may determine the text associated with each of the plurality of content segments. For example, text associated with each of the plurality of content segments may include closed-captioning data, text detected within the content, dialogue provided as text for the content, summaries of the content, descriptions of the content, third-party descriptions of the content, social media descriptions of the content, and the like. For example, each content segment of the source content items 102 may include embedded text (e.g., detected text or closed-captioning data in the CEA-608 or CEA-708 format) for that content segment or a subsequent content segment (e.g., the next sequential content segment). The text may include a text string of words associated with the content segment (e.g., the dialogue occurring during the content segment or a subsequent content segment, a description of a scene occurring during that content segment or a subsequent content segment, a description of audio (e.g., music, sounds) occurring during that content segment or a subsequent content segment, etc.). The captions module 113 of the segment engine 111 may parse the content segment and identify and/or retrieve the text associated with (e.g., included with) the content segment.

The captions module 113 may modify one or more of the words within the text for the particular content segment. For example, the captions module 113 may normalize one or more of the words within the text for the content segment. For example, in normalizing the one or more words, the captions module 113 may modify any plural form of a word into a singular form of that word, may modify any possessive form of a word into a non-possessive form of the word, may modify all verbs within the text from past or future tense to present tense, may remove all articles (e.g., a, an, the) from the text, etc.

The captions module 113 may associate the modified or unmodified text for the particular content segment with a time value. For example, the captions module 113 may associate the modified text with a time value. The time value may be the time the content segment was created, the time the text was parsed from the content segment, or the time of the content segment in the content. The captions module 113 may also associate the text associated with the particular content segment with other information including, but not limited to, the segment number or segment identifier for the content segment from which the text was retrieved, the title of the content, the content channel for the content, etc.

The captions module 113 may transfer or otherwise send the modified or unmodified text to the topic engine 160 (e.g., the text data 162). In examples where the captions module 113 and topic engine 160 are part of the same computing device (e.g., computing device 110), the transfer may be an internal transfer of the modified or unmodified text. The topic engine 160 may receive the text and may store the text in the text data storage device 162 for subsequent use.

At 550, the computing device (e.g., the computing device 110 or the topic engine 160) may determine frequency value information for each topic of the list of the plurality of determined topics for each of the plurality of segments. For example, the topic engine 160 may determine a quantity of each topic referenced in the modified or unmodified text for a period of time (e.g., the prior 24 hours, 2 days, 3 days or any other time period between and including 1 hour to 1 year) in each of the plurality of content segments. The quantity may represent the frequency value information for the particular topic in each of the plurality of content segments. For example, the computing device 110 may also determine a topic or topics to assign to each particular segment of the plurality of content segments, if any. For example, the topic engine 160 may compare the words of the text associated with each of the plurality of content segments to each of the plurality of topics to determine if any of the words of the text (e.g., modified or unmodified) match one or more of the plurality of topics. When a match of one or more of the words in the text associated with a content segment of the plurality of content segments to one of the plurality of topics is determined, the topic engine 160 may store an indication of the match (e.g., may increment a counter variable for the particular topic of the plurality of topics). The topic engine 160 may also determine the topic or topics to assign or associate with each particular content segment, if any. For example, the topic engine 160 may associate, with the particular content segment, each topic that matches a word or phrase within the particular content segment. For example, the topic engine 160 may associate, with the particular content segment, the topic with the greatest number of matches to the text within the particular content segment.

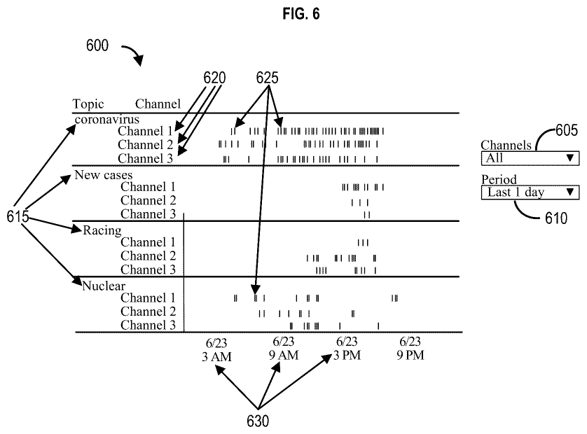

The topic engine 160 may also store a copy of or an indication of the content segment of the content that included the match to the one or more topics of the plurality of topics (e.g., a URL of the content segment, an identifier of the content segment (e.g., content title and segment number), etc.). The topic engine 160 may associate the copy or indication of the content segment with the indication of the match, such that, in response to a user selecting (e.g., via user device 190) an indication of a topic match for one of the plurality of topics for a content channel (see FIG. 6), the computing device 110 or the topic engine 160 will retrieve and present for display a copy of the content segment (or a plurality of content segments that include the content segment with the matching text) for viewing by the user via the user device 190.

The topic engine 160 may determine the frequency value information for each topic and for each content channel (e.g., Channel 1, Channel 2, Channel 3, etc.) from which the plurality of content segments of the content was received. For example, the plurality of topics may include the words “tax” and “infrastructure”. One modified content segment for a first news channel may include the words “today Congress discuss tax on fuel fund infrastructure,” and a second modified content segment for the first news channel may include the words “President propose reduce tax on family”. A first modified content segment for a second news channel may include the words “fire broke out in Colorado” and the second modified content segment for the second news channel may include the words “work overtime is tax on family life.” In this example, the first news channel may have the following frequency value information: tax (2), infrastructure (1), while the second news channel may have the following frequency value information: tax (1) infrastructure (0).

The topic engine 160 may determine the frequency value information for a particular time period of the content provided by the particular content channel (e.g., 1 day of content, 2 days of content, 3 days of content, or any other time period between and including 1 hour to 1 year). For example, the topic engine 160 may continuously compare the text for the content channel providing the content to the plurality of topics for a rolling three-day period. In this example, as new text is received from the content channel and compared to the plurality of topics, the previously determined frequency value information that is older than the particular time period (e.g., in this example, three days) will be removed or deleted from the frequency value information for the content channel. The time period may be a pre-set time period or may be selected by a user via the user device 190 and a user interface.

The topic engine 160 may sum all of the matches for one or more of the topics (e.g., each topic) of the plurality of topics for the particular content channel and for the time period of the content provided by the particular content channel (e.g., 1 day of content, 2 days of content, 3 days of content or any other time period between and including 1 hour to 1 year) to determine the frequency value information for each topic of the plurality of topics for that particular content channel. The sum of all of the matches for a topic and for a content channel may represent the frequency value information for the topic of that content channel.

At 560, a computing device (e.g., the computing device 110 or the topic engine 160 may determine if there is additional content (e.g., another source content item (e.g., from one or more other content channels)) to evaluate for frequency value information. For example, the topic engine 160 may determine the frequency value information for each content channel providing content, a portion of the content channels providing content (e.g., based on the type of content channel (e.g., news channels (which may be separated into national news channels and local news channels), sports channels, weather channels, movie channels, comedy channels, music channels, etc.), or just one content channel providing content. For example, the determination of which content channels to evaluate may be predetermined or set based on user preferences received from the user device 190. For example, if the computing device 110 determines that another source content item 102 is to be evaluated, the YES branch may be followed to 520. If the computing device 110 determines that there is not another source content item 102 to be evaluated, the NO branch may be followed to 570.

At 570, a computing device (e.g., the computing device 110 or the topic engine 160) may send or otherwise present the results indicating the frequency value information. For example, the computing device 110 may send the results indicating the frequency value information to the user device 190 via the network 104. For example, the results may be sent to the user device 190 in response to a request received from the user device 190 for the frequency value information for one or more content channels. The request may include the content channel or channels (or content sources) that the user associated with the user device 190 wants to receive associated frequency value information. The request may also include a time period (e.g., a selection of hours, days, or weeks) for which the user associated with the user device 190 wants to receive associated frequency value information. If no time period is provided in the request, the computing device 110 may revert to one or more default time periods (e.g., one day, two days, three days, one week, two weeks, one month, or any other time period between 1 hour and 1 year). The request may also include a user identifier (e.g., a user name, user network address, user device ID or another form of unique identifier). Based on the selected content channels and/or sources and the selected time period, the computing device 110 may determine the frequency value information for the requested channels during the request time period as described above and may present those results to the user via presenting or displaying the results on the user device 190. For example, the results may be presented in the form of a table or any other format.

FIG. 6 shows an example table 600 of results indicating frequency value information for multiple content channels. For example, the request from the user device 190 may include the content channels and/or content sources for which frequency value information is requested (e.g., the specific content channels or based on the primary content provided by content channels (e.g., national news, weather, local news, sports, movies, comedy, music, etc.)). The content channels may be selected by a user via a channel drop-down box 605 or another method. The request from the user device 190 may also include the time period to analyze the content of the selected content channels for (e.g., 1 day of content, 2 days of content, 3 days of content or any other time period between and including 1 hour to 1 year). For example, the time period may be selected by a user via a time period drop-down box 610 or another method.

The topic engine 160 or another portion of the computing device 110 may receive the request and generate the results indicating the frequency value information for the plurality of topics for one or more content channels based on the content received. For example, the results may be in the form of the table 600. For example, the table 600 may include the plurality of topics 615 along one axis of the table and the time period 630 analyzed along another axis of the table. For example, each topic 615 of the plurality of topics may further include the listing of one or more of the content channels 620 evaluated. For example, the listing of content channels 620 may include all of the content channels evaluated for frequency value information. In another example, the listing of content channels 620 may include only a portion of the content channels evaluated (e.g., a predetermined quantity (e.g., any quantity between 1-10 content channels) of content channels ordered based on the quantity of matches for the frequency value information). For example, the topic engine 160 may organize the evaluated content channels based on the frequency value information for each content channel for a particular topic. For example, the topic engine 160 may organize the evaluated content channels from highest frequency value information (e.g., most matches for a particular topic during the time period) to lowest frequency value information (e.g., fewest matches for a particular topic during the time period).

The table 600 may also include an indication 625 of each matching text to the particular topic of the plurality of topics 615 for the particular content channel. For example, the indication 625 may be aligned on the table 600 based on the time the particular indication 625 occurred in the text associated with the particular content channel 620. For example, the indication 630 may be a mark (e.g., line, dot, etc.) on the table 600. For example, the indication 630 may include a link to the content segment (or a plurality of content segments that include the content segment with the matching text (e.g., a URL of the content segment, an identifier of the content segment (e.g., content title and segment number)) for selection via the user device 190 and display (e.g., playing) of the content segment (or plurality of content segments including the content segment with the matching text) on the user device 190.

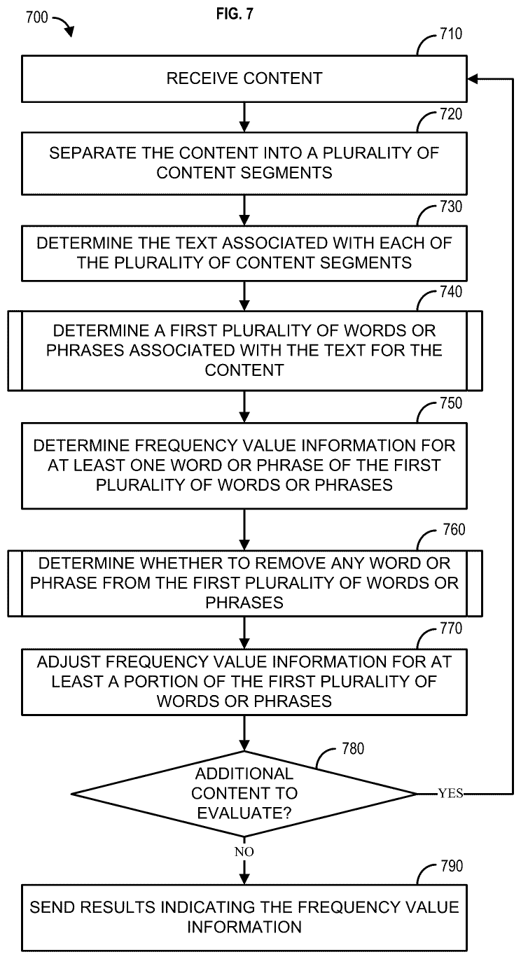

FIG. 7 shows a flowchart of an example method 700 for determining usage of words in content. For example, the computing device 110 and/or the keyword engine 170 may receive a plurality of content items (e.g., streams of content or VOD content) for a plurality of content channels and may evaluate text (e.g., closed-captioning data) within the content to determine the frequency with which words or phrases are used within the content for each content channel over a predetermined or user-selected period of time.

At 710, the computing device (e.g., the computing device 110 and/or the keyword engine 170) may receive one or more source content items 102 (e.g., a content stream or VOD content). The one or more source content items 102 may contain audio content, video content, or a combination of audio and video content. For example, each of the one or more source content items 102 may be live content (e.g., a linear content stream) or VOD content. For example, the computing device 110 may receive each of the one or more source content items 102 from an external source (e.g., a stream capture source, a data storage device, a media server, etc.) via a wired or wireless network connection, such as the network 104 or another network (not shown). For example, each of the one or more source content items 102 may be from one or more content channels (e.g., Channel 1, Channel 2, Channel 3, etc.) For example, the computing device 110 may receive a plurality of source content items 102 concurrently. The plurality of source content items 102 may each be associated with one or more different content channels.

At 720, the computing device (e.g., a segmenter 131 of the computing device 110) may separate each of the one or more source content items 102 into a plurality of content segments. Each content segment for each of the one or more source content items 102 may include a portion of the source content item 102. For example, the segmenter 131 of the packager 130 may separate the source content item 102 into sequential content segments in chronological order of the source content item 102. The segmenter 131 may assign a unique content segment identifier to each content segment of the plurality of content segments created. For example, the unique content segment identifier may be or include a segment number. For example, the segmenter 131 may initiate a counter associated with the particular source content item 102 (e.g., starting the counter at 0 or 1) and increment the counter for each segment that is created from the source content item 102. In other examples, the unique content segment identifier may be a full or partial URL address, another form of counter variable, or another unique identifier.

For example, the source content item 102 may be separated into content segments having a predetermined data size or time duration. For example, the segmenter 131 may have a target segment duration of two thousand milliseconds (or another desired length of duration, such as any time period between 0-60 seconds). The target segment duration may be a preset amount, received via user input, or dynamically determined based on properties of the source content item 102 or the packager 130. For example, if the target segment duration is two seconds, the segmenter 131 may process the incoming source content items 102 and break the source content items 102 into segments at key frame boundaries in the content approximately two seconds apart. Further, if the source content item 102 includes separate video and audio content, the segmenter 131 may generate the content segments such that the separate content segments of video and audio content are timecode aligned.

At 730, the computing device (e.g., the computing device 110 and/or captions module 113 of the segment engine 111) may determine the text associated with each of the plurality of content segments. For example, text associated with each of the plurality of content segments may include closed-captioning data, text detected within the content segment, dialogue provided as text for the content segment, summaries of the content, descriptions of the content, third-party descriptions of the content, social media descriptions of the content, and the like. For example, each content segment of the source content item 102 may include embedded text (e.g., detected text or closed-captioning data in the CEA-608 or CEA-708 format) for that content segment or a subsequent content segment (e.g., the next sequential content segment). The text may include a text string of words associated with the content segment (e.g., the dialogue occurring during the content segment or a subsequent content segment, a description of a scene occurring during that content segment or a subsequent content segment, a description of audio (e.g., music, sounds) occurring during that content segment or a subsequent content segment, etc.). The captions module 113 of the segment engine 111 may parse the content segment and identify and/or retrieve the text associated with (e.g., included with) the content segment.

The captions module 113 may associate the text for the particular content segment with a time value. For example, the captions module 113 may associate the text with a time value. The time value may be the time the content segment was created, the time the text was parsed from the content segment, or the time of the content segment in the content. The captions module 113 may also associate the text for the particular content segment with other information including, but not limited to, the segment number or segment identifier for the content segment from which the text was retrieved, the title of the content, the content channel for the content, etc.

The captions module 113 may transfer or otherwise send the text to the keyword engine 170 (e.g., the text data 171). In examples where the captions module 113 and keyword engine 170 are part of the same computing device (e.g., computing device 110), the transfer may be an internal transfer of the text. The keyword engine 170 may receive the text and may store the text in the text data storage device 171 for subsequent use.

At 740, a computing device (e.g., the computing device 110 or the keyword engine 170) may determine a first plurality of words and/or phrases associated with the text associated with the content 102. For example, the keyword engine 170 may evaluate the words within the text for each content segment and include all or a portion of the words of each respective content segment as part of the first plurality of words or phrases associated with the text for the particular content segment. For example, the keyword engine 170 may modify one or more of the words within the text associated with each content segment and include the modified one or more words of the particular content segment as part of the first plurality of words or phrases.

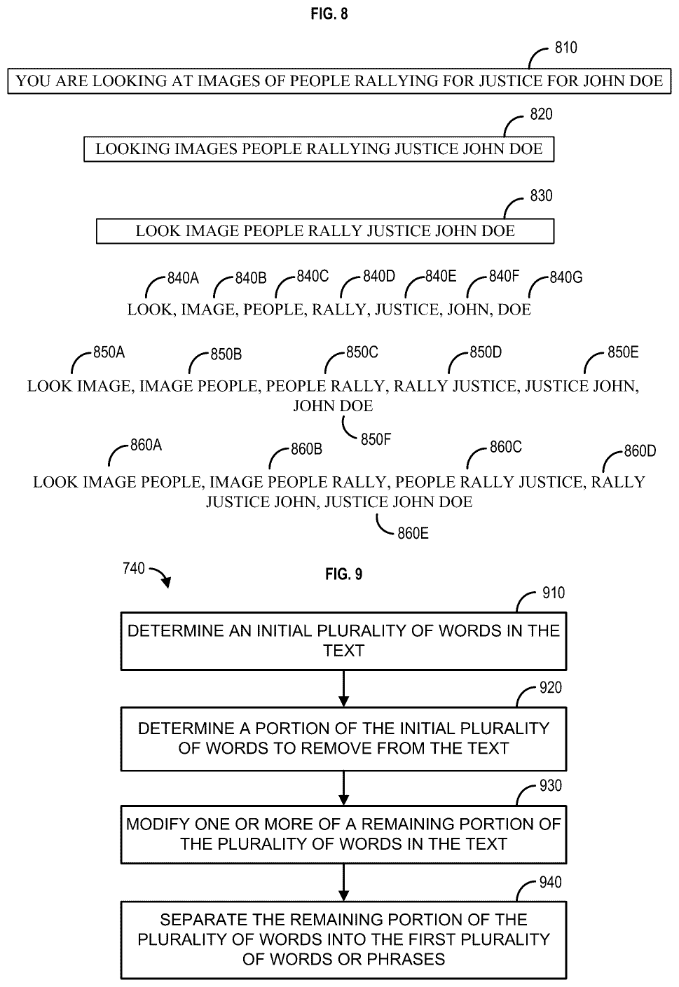

FIG. 8 shows a block diagram of an example determination of the first plurality of words or phrases in the content. FIG. 9 shows a flowchart of an example method 900 for determining the first plurality of words or phrases in the content. For example, a computing device (e.g. the computing device 110 or the keyword engine 170) may evaluate the words in the text associated with each content segment and determine the first plurality of words and phrases based on the words within the text. At 910, the keyword engine 170 may determine an initial plurality of words 810 in the text for each content segment of the content. For example, the keyword engine 170 may receive the text from the segment engine 111 or from a storage device (e.g., the text data storage device 171. For example, text associated with each content segment may include closed-captioning data, text detected within the content, dialogue provided as text for the content, summaries of the content, descriptions of the content, third-party descriptions of the content, social media descriptions of the content, and the like. For example, the initial plurality of words 810 in the text for one content segment may be “you are looking at images of people rallying for justice for John Doe.”

At 920, a computing device (e.g., the computing device 110 or the keyword engine 170 may determine a portion of the initial plurality of words 810 in the text for the content segment to remove from analysis. For example, the keyword engine 170 may identify and remove all or a portion of the articles (e.g., a, an, the) from the initial plurality of words 810. For example, the keyword engine 170 may identify and remove all or a portion of the prepositions from the initial plurality of words 810. For example, the keyword engine 170 may identify and remove all or a portion of the pronouns from the initial plurality of words 810. For example, the determination as to which articles, propositions, and pronouns to remove from the initial plurality of words 810 may be predetermined. In addition, other terms or groups of terms may be identified and removed from initial plurality of words 810. For example, removing the articles, prepositions, and pronouns from the initial plurality of words 810 may result in a remaining portion of the initial plurality of words 820 that includes “looking images people rallying justice John Doe.”

At 930, a computing device (e.g., the computing device 110 or the keyword engine 170) may modify one or more of the remaining portion of the initial plurality of words 820 in the text. For example, the keyword engine 170 may modify or normalize one or more of the words within the remaining portion of the initial plurality of words 820 of the text for the particular content segment. For example, in modifying or normalizing the one or more of the words within the remaining portion of the initial plurality of words 820, the keyword engine 170 may modify any plural form of a word into a singular form of that word, may modify any possessive form of a word into a non-possessive form of the word, and/or may modify all verbs within the text from past or future tense to present tense, etc. For example, modifying or normalizing one or more of the words within the remaining portion of the initial plurality of words 820 “looking images people rallying justice John Doe” may result in the modified remaining portion of the initial plurality of words 830 that includes “look image people rally justice John Doe.”

At 940, a computing device (e.g., the computing device 110 or the keyword engine 170) may separate the modified remaining portion of the initial plurality of words 830 into the first plurality of words or phrases (e.g., 840A-G, 850A-E, and/or 860A-E). For example, the keyword engine 170 may include each word 840A-G in the modified remaining portion of the initial plurality of words 830 as one of the first plurality of words or phrases. In this example, the words look 840A, image 840B, people 840C, rally 840D, justice 840E, John 840F, and Doe 840G may each be included in the first plurality of words or phrases. In addition, the keyword engine 170 may generate phrase combinations from the modified remaining portion of the initial plurality of words. The creation of phrase combinations for comparison may result in more detailed matching of words or phrases that are included in the text a large number of times over the time period evaluated for one or more of the content channels for which content is received. For example, during the time period, the keyword engine 170 may determine that the word “holiday” is used 400 times and that the phrase “Memorial Day holiday” is used 200 times. The reference to “holiday” alone is not very specific and may be related to content discussing any number of holidays. However, the reference to “Memorial Day holiday” is much more specific and the significant quantity of times that it is mentioned during the time period evaluated may be of interest to a user.

For example, the keyword engine 170 may generate phrases from the modified remaining portion of the initial plurality of words 830 by combining one or more of those words together. For example, the keyword engine 170 may generate phrases from the modified remaining portion of the initial plurality of words 830 by combining two adjacent words of the modified remaining portion of the initial plurality of words 830 together. For example, based on the modified remaining portion of the initial plurality of words 830, the keyword engine 170 may generate the phrases “look image” 850A, “image people” 850B, “people rally” 850C, “rally justice” 850D, “justice John” 850E, and “John Doe” 850F. For example, the keyword engine 170 may also or alternatively generate phrases from the modified remaining portion of the initial plurality of words 830 by combining three adjacent words together. For example, based on the modified remaining portion of the initial plurality of words 830 the keyword engine 170 may generate the phrases “look image people” 860A, “image people rally” 860B, “people rally justice” 860C, “rally justice John” 860D, and “justice John Doe” 860E.

While the creation of phrases above describes combining two and three words together for inclusion in the first plurality of words or phrases, this is for example purposes only as no words may be combined or any number of words may be combined to generate example phrases for the first plurality of words or phrases. In the example above, based on words in the modified remaining portion of the initial plurality of words 830, the first plurality of words or phrases may include look 840A, image 840B, people 840C, rally 840D, justice 840E, John 840F, Doe 840G, “look image” 850A, “image people” 850B, “people rally” 850C, “rally justice” 850D, “justice John” 850E, “John Doe” 850F, “look image people” 860A, “image people rally” 860B, “people rally justice” 860C, “rally justice John” 860D, and “justice John Doe” 860E.

The keyword engine 170 may associate each of the first plurality of words or phrases for each content segment of the content for each content channel with a time value. The time value may be the time the content segment from which the first plurality of words or phrases was created, the time the text was parsed from the content segment, or the time of the content segment in the content. The keyword engine 170 may also associate each of the first plurality of words or phrases for each content segment with other information including, but not limited to, the segment number or segment identifier for the content segment from which the first plurality of words or phrases was generated, the title of the content, the content channel for the content, etc. For example, the keyword engine 170 may include the associated information in metadata associated with the respective word or phrase of the first plurality of words or phrases, in a manifest file, in a table, or in another manner. The first plurality of words or phrases for each content segment of the content for each content channel may be stored in the text data storage device 171 of the keyword engine 170 or another storage device

Retuning to FIG. 7, at 750 a computing device (e.g., the computing device 110 or the keyword engine 170) may determine frequency value information for at least one word or phrase of the first plurality of words or phrases for each content segment of the content for the content channel for the time period being analyzed. For example, the keyword engine 170 may determine a quantity of each of the plurality of words or phrases determined from the text associated with a content channel for a period of time (e.g., the prior 24 hours, 2 days, 3 days or any other time period between and including 1 hour to 1 year).

The quantity may represent the frequency value information for the particular word or phrase. For example, the keyword engine 170 may compare each word or phrase determined during the time period (e.g., the first plurality of words or phrases for each content segment of the content and for the content channel) to each other word or phrase determined during that time period from the content for that content channel to determine if any of the words or phrases match. For example, the keyword engine 170 may determine the quantity of times that the word “image” 840B occurred in the content for the content channel for the period of time. Similarly, the keyword engine 170 may determine the quantity of times that the phrase “people rally” 850C occurred in the content for the content channel for the period of time.

For example, when the keyword engine 170 determines a match of a word or phrase of the first plurality of words or phrases to another word or phrase determined during that time period from the content for that content channel, the keyword engine 170 may store an indication of the match (e.g., may increment a counter variable for the particular word or phrase). The keyword engine 170 may also store a copy of or an indication of the content segment of the content that included the matching word or phrase (e.g., a URL of the content segment, an identifier of the content segment (e.g., content title and segment number), etc.). The keyword engine 170 may associate the copy or indication of the content segment with the indication of the match, such that, in response to a user selecting (e.g., via user device 190) an indication of a word or phrase match for one of the first plurality of words or phrases for a content channel (see FIG. 14), the computing device 110 or the keyword engine 170 will retrieve and present for display a copy of the content segment (or a plurality of content segments that include the content segment with the selected matching word or phrase) for viewing by the user via the user device 190.

The keyword engine 170 may determine the frequency value information for each word or phrase of the first plurality of words or phrases for each content segment of the content and for each content channel (e.g., Channel 1, Channel 2, Channel 3, etc.) from which the content was received. The keyword engine 170 may determine the frequency value information for a particular time period of the content provided by the particular content channel (e.g., 1 day of content, 2 days of content, 3 days of content, or any other time period between and including 1 hour to 1 year). For example, the keyword engine 170 may continuously compare the word or phrase for each of the first plurality of words or phrases for each content segment of the content for the content channel to each other word or phrase in the first plurality of words or phrases for each content segment of the content of the content channel for a rolling three-day period. In this example, as new words or phrases (e.g., the first plurality of words or phrases) for new content segments are received from the content channel and compared to the previously stored first plurality of words or phrases for the content segments of the content of the content channel, the previously determined words or phrases that are older than the particular time period (e.g., in this example, three days) will be removed or deleted from the analysis for the frequency value information for the content channel. The time period may be a pre-set time period or may be selected by a user via the user device 190 and a user interface.

The keyword engine 170 may sum all of the instances of the words and/or phrases for the particular content channel and for the time period of the content provided by the particular content channel (e.g., 1 day of content, 2 days of content, 3 days of content or any other time period between and including 1 hour to 1 year) to determine the frequency value information for each word and/or phrase. For example, the keyword engine 170 may sum up the quantity of times that the word “image” 850B is in first plurality of words or phrases for all of the content segments of the content of the content channel for the time period. Similarly, the keyword engine 170 may sum up the quantity of times that the phrase “John Doe” 850F is in the first plurality of words or phrases for all of the content segments of the content of the content channel for the time period. The sum of all of the instances of a word or phrase in the content for the content channel for the time period may represent the frequency value information for that particular word or phrase for that content channel.

At 760, a computing device (e.g., the computing device 110 or the keyword engine 170) may determine whether to remove any word or phrase from the first plurality of words or phrases. For example, the keyword engine 170 may determine whether to remove a word or phrase from the first plurality of words or phrase for which frequency value information was determined. For example, some words or phrases may always or almost always have a significant quantity of instances in the content, and may not be indicative of current events. This may be caused by words or phrases that are often part of the content, no matter what current events are occurring, or because they are included in the language of commercials.

For example, certain words or phrases, such as “thank you,” “good morning,” “president” may have a significant number of occurrences during each day or almost each day of a time period. However, the use of these terms is not an indicator of a trending or current event. Rather, those words or phrases are simply ones that are used on a consistent basis. For example, it is not unusual for a topic related to the President of the United States to be discussed at least daily by one or more content channels. Accordingly, evaluating each word or phrase to determine a median daily frequency of how often the word or phrase is included within the text of the source content items may indicate whether the particular word is one that is being generically used over time. By identifying these words or phrases and removing them from further analysis, it may provide a better indication of topics that are current and/or trending. Further, removing these more generically used words and phrases does not mean that trending topics associated with them might not still be identified. For example, content having the words “president impeached” may have the word “impeached” continue on for further analysis, while in another example, “president met today” may not have any of the additional words associated with “president” move on for further analysis.

In a similar manner, repetitive items that change over time may indicate certain words or phrases may seem to be related to a significant trending or current event but are actually not. For example, commercials for a particular product may be included in the source content time for a particular channel. These commercials may typically have the same or similar words or phrases included to promote the products or services associated with the commercial. By identifying the words or phrases associated with commercials and removing them from further analysis, it may provide a better indication of topics that are current and/or trending and not identify a topic associated with a prolific advertising campaign.

In a similar manner, certain words or phrases within the text may be presented in multiple formats but may represent the same topic. For example, the “affordable care act” and “care act” are phrases that may both be identified within the text for a period of time. If each is used significant, it may be possible for both phrases to be separately identified as trending topics even though they actually cover the same general topic. It may be beneficial to evaluate the content of the words or phrases identified in the text to remove terms or phrases that have an overlap that satisfies an overlap threshold. This may result in a reduction of identified current or trending topics that are really for the same single topic.

The keyword engine 170 may determine to remove one or more words based on one or more factors including, but not limited to, how repetitive the word or phrase is over multiple periods of time, whether the word or phrase typically has a non-zero frequency value information over multiple periods of time, and/or how much the word or phrase overlaps with another word or phrase in the first plurality of words or phrases for all the content segments of the content for the period of time. The keyword engine 170 may remove those words or phrases based on the one or more factors.

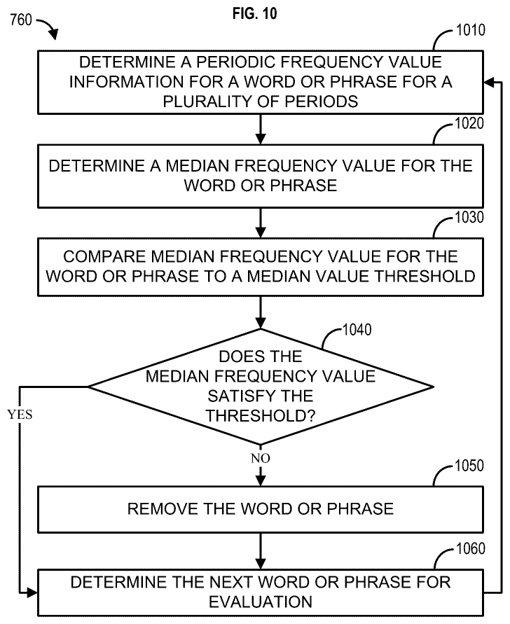

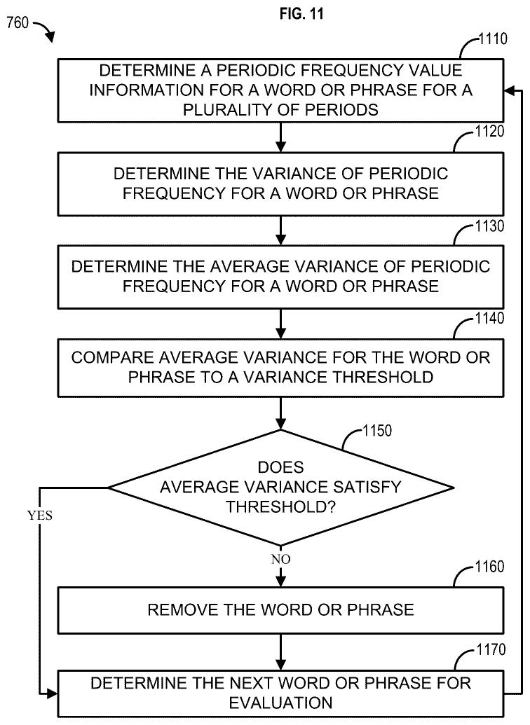

For example, the computing device 110 may determine the frequency value information for the at least one word or phrase of the first plurality of words or phrases for a second period of time. For example, this frequency value information determination may have previously occurred and been stored for the particular word or phrase or may occur once the first plurality of words or phrases are determined. For example, the second time period may comprise one or more periods of time that occur prior to the current time period being analyzed. For example, the second period of time may comprise the time period being analyzed and one or more periods of time prior to the time period being analyzed. For example, the computing device 110 may determine that the frequency value information for the second period of time for a first portion of the first plurality of words or phrases does not satisfy one or more thresholds, such as the media value threshold discussed in FIG. 10 and variance threshold discussed in FIG. 11. Based on the frequency value information during the second period of time for the first portion of the first plurality of words or phrases not satisfying the threshold, the computing device 110 may remove the first portion of the words or phrases from the first plurality of words or phrases or may take no further action with regard to the first portion of the words or phrases (e.g., won't send the results indicating the frequency value information for the first portion of the words or phrases as discussed at 790). The computing device 110 may move forward with analysis of the remaining portion (or second portion) of the first plurality of words or phrases for which the frequency value information during the second period of time satisfies the threshold.

FIG. 10 shows a flowchart of an example method 760 for removing one or more words or phrases identified in the content from analysis. For example, the method of FIG. 10 may be used to remove certain “generic” words or phrases that are frequently in the content being analyzed, such as “president” or “congress” in news content. These are the phrases that are used so consistently on a day-to-day basis that they are rendered almost “generic” and not indicative of a particular event or news item even though the frequency of that word or phrase might be high. It should be understood that other words or phrases proximate these consistently used words or phrases (e.g., “president health”) and that provide additional context to these consistently used words or phrases may be used less frequently and/or consistently and may limit or prevent the removal of the otherwise consistently used word or phrase.

At 1010, a computing device (e.g., the computing device 110 or the keyword engine 170) may determine, for a plurality of periods (e.g., time periods) a periodic frequency value information for a word or phrase of the first plurality of words or phrases for which a frequency value information was determined. For example, the periodic frequency value information may equal the frequency value information for the word or phrase. For example, the periodic frequency value information may be different than the frequency value information for the word or phrase. The periodic frequency value information may be the quantity of the word or phrase in the first plurality of words or phrases for each content segment of the content for the content channel over a specified period of time (e.g., 1 day, 1 week, 1 month or any other time period between and including 1 hour to 1 year). For example, the plurality of periods may be configurable and may be any amount between and including 1 day to 1 year (e.g., 1 month, 2 months, 3 months, 1 week, 3 weeks, etc.). For example, the time period for the periodic frequency value information may be one day and the plurality of periods may be 90 days.

For example, the keyword engine 170 may determine the periodic frequency value information for a word or phrase for each period (e.g., each day) for the predetermined plurality of periods (e.g., 90 days). For example, the keyword engine 170 may retrieve the stored first plurality of words or phrases for each content segment of the content for the content channel from text data storage device 171 and determine the number of instances of the word or phrase in the first plurality of words or phrases for each content segment of the content for the content channel during the period (e.g., during the one day period) for each of the plurality of periods (e.g., the most recent 90 days of the content for the content channel). The result is a plurality of periodic frequency value information for the word or phrase that cover the plurality of periods.

At 1020, a computing device (e.g., the computing device 110 or the keyword engine 170) may determine the median frequency value for the word or phrase. For example, the median frequency value for the word or phrase may be based on the plurality of periodic frequency value information for the word or phrase. For example, the median frequency value for the word or phrase may be the median of the plurality of periodic frequency value information for the word or phrase. For example, given a period of 1 day and a plurality of periods that covers 1 week, the example periodic frequency value for the word or phrase may be as follows: 0, 0, 0, 0, 2, 25, 120. In this example, the median frequency value for the word or phrase would be zero. In another example, given a period of 1 day and a plurality of periods that covers 1 week, the example periodic frequency value for the word or phrase may be as follows: 2, 4, 4, 8, 10, 10, 11. In this example, the median frequency value for the word or phrase would be eight.

At 1030, a computing device (e.g., the computing device 110 or the keyword engine 170 may compare the median frequency value for the word or phrase to a median value threshold. The median value threshold may be a predetermined value or a user-selectable value. The median value threshold can be any value greater than or equal to zero. For example, the median value threshold may be zero. Providing a median value threshold of zero may result in eliminating any word or phrase with a median frequency value that is greater than zero and thus, more consistently used in the content, which may indicate the use of the word or phrase in the content is not based on a recent event. Conversely, words or phrases with a median frequency value that less than or equal to the threshold (e.g., satisfies the threshold), such as a zero median frequency value, may indicate that the use of the word or phrase in the content is associated with a recent event because it had not been used for a period of time and then began being used.

For example, the keyword engine 170 may compare the median frequency value for the word or phrase to the median value threshold to determine if the median frequency value satisfies the median value threshold. For example, the median frequency value may satisfy the median value threshold if the median frequency value is less than or less than or equal to the median value threshold. At 1040, a computing device (e.g., the computing device 110 or the keyword engine 170) may determine if the median frequency value for the word or phrase satisfies the median value threshold. If the median frequency value for the word or phrase does not satisfy the median value threshold (e.g., the median frequency value is greater than or greater than or equal to the median value threshold), then the NO branch may be followed to 1050. If the median frequency value for the word or phrase satisfies the median value threshold (e.g., the median frequency value is less than or less than or equal to the median value threshold) then the YES branch may be followed to 1060.

At 1050, a computing device (e.g., the computing device 110 or the keyword engine 170) may remove the word or phrase from the first plurality of words or phrases for which a frequency value information was determined for the particular content channel. At 1060, a computing device (e.g., the computing device 110 or the keyword engine 170) may determine a next word or phrase of the first plurality of words or phrases for which a frequency value information was determined for the particular content channel for analysis. For example, the keyword engine 170 may determine if one or more words or phrases of the first plurality of words or phrases for which a frequency value information was determined for the content channel have not yet been analyzed and may select the next word or phrase for analysis and the method may be followed back to 1010. The method of FIG. 10 may be completed for each of the first plurality of words or phrases for which a frequency value information was determined for each of the plurality of content channels (e.g., the content channels predetermined for review or the content channels selected by the user for review).

FIG. 11 shows a flowchart of another example method 760 for removing one or more words or phrases identified in the content from analysis. At 1110, a computing device (e.g., the computing device 110 or the keyword engine 170) may determine, for a plurality of periods (e.g., time periods) a periodic frequency value information for a word or phrase of the first plurality of words or phrases for which a frequency value information was determined. For example, the periodic frequency value information may equal the frequency value information for the word or phrase. For example, the periodic frequency value information may be different than the frequency value information for the word or phrase. The periodic frequency value information may be the quantity of the word or phrase in the first plurality of words or phrases for each content segment of the content for the content channel over a specified period of time (e.g., 1 day, 1 week, 1 month or any other time period between and including 1 hour to 1 year). For example, the plurality of periods may be configurable and may be any amount between and including 1 day to 1 year (e.g., 1 month, 2 months, 3 months, 1 week, 3 weeks, etc.). For example, the time period for the periodic frequency value information may be one day and the plurality of periods may be 90 days.

For example, the keyword engine 170 may determine the periodic frequency value information for a word or phrase for each period (e.g., each day) for the predetermined plurality of periods (e.g., 90 days). For example, the keyword engine 170 may retrieve the stored first plurality of words or phrases for each content segment of the content for the content channel from text data storage device 171 and determine the number of instances of the word or phrase in the first plurality of words or phrases for each content segment of the content for the content channel during the period (e.g., during the one day period) for each of the plurality of periods (e.g., the most recent 90 days of the content for the content channel). The result is a plurality of periodic frequency value information for the word or phrase that cover the plurality of periods.

At 1120, a computing device (e.g., the computing device 110 or the keyword engine 170) may determine variance of the periodic frequency value information for the word or phrase from period to period over the plurality of periods. For example, the variance of the periodic frequency value information for the word or phrase may be based on the plurality of periodic frequency value information for the word or phrase. For example, given a period of 1 day and a plurality of periods that covers 1 week, the example periodic frequency value for the word or phrase may be as follows: 5, 8, 30, 45, 10, 2, 1. In this example, the variance of the periodic frequency value information for the word or phrase from period to period over the plurality of periods would be 3 (e.g., 8-5), 22 (e.g., 30-8), 15 (e.g., 45-30), 35 (e.g., 45-10), 8 (e.g., 10-2), and 1 (e.g., 2-1). In another example, given a period of 1 day and a plurality of periods that covers 1 week, the example periodic frequency value for the word or phrase may be as follows: 10, 10, 10, 10, 10, 10, 11. In this example, the variance of the periodic frequency value information for the word or phrase from period to period over the plurality of periods would be 0, 0, 0, 0, 0, 1. A low variance of the periodic frequency value information may represent that the word or phrase is being used a similar (or same) number of times during each period. The low variance of the periodic frequency value information may represent that the word or phrase is being used in a commercial on the content channel and that the commercial is appearing a generally consistent quantity of times in each period (e.g., each day). As information from commercials (or identifying commercials that are using particular words or phrases) is typically not desired by a user, it may be advantageous to remove these words or phrases (and the associated video content in the form of the content segment or plurality of content segments associated with each instance of the word or phrase) from the first plurality of words or phrases for which a frequency value information was determined.

At 1130, a computing device (e.g., the computing device 110 or the keyword engine 170) may determine the average variance of periodic frequency for the word or phrase. For example, the keyword engine 170 may determine a sum of the variance of periodic frequency for the plurality of period. The keyword engine 170 may divide the sum by the quantity of variances included in the sum to generate the average variance of periodic frequency for the word or phrase. For example, given the variance of periodic frequency value information of 3, 22, 15, 35, 8, 1, as discussed above, the sum of the variance of period frequency value information would be 3+22+15+35+8+1, which equals 84 and the average variance of periodic frequency for the word or phrase would be 84 divided by 6, which equals 14. In another example, given the variance of periodic frequency value information of 0, 0, 0, 0, 0, 1, as discussed above, the sum of the variance of period frequency value information would be 0+0+0+0+0+1, which equals 1 and the average variance of periodic frequency for the word or phrase would be 1 divided by 6, which equals 0.167.

At 1140, a computing device (e.g., computing device 110 or keyword engine 170) may compare the average variance for the word or phrase over the plurality of periods to a variance threshold. The variance threshold may be a predetermined value or a user-selectable value. The variance threshold can be any value greater than or equal to zero. For example, the variance threshold may be a small value (e.g., 10, 5, 1, or 0). Providing a variance threshold with a small value may capture those words or phrases that are more consistently used in each period of the plurality of periods for the content, which may indicate the word or phrase is being used in connection with one or more commercials. For example, the keyword engine 170 may compare the average variance for the word or phrase to the variance threshold to determine if the average variance satisfies the variance threshold. For example, the average variance may satisfy the variance threshold if the average variance is greater than or greater than or equal to the variance threshold. At 1150, a computing device (e.g., the computing device 110 or the keyword engine 170) may determine if the average variance for the word or phrase satisfies the variance threshold. If the average variance for the word or phrase does not satisfy the variance threshold (e.g., the average variance is less than or less than or equal to the variance threshold), then the NO branch may be followed to 1160. If the average variance for the word or phrase satisfies the variance threshold (e.g., the average variance is greater than or greater than or equal to the variance threshold) then the YES branch may be followed to 1170.

At 1160, a computing device (e.g., the computing device 110 or the keyword engine 170) may remove the word or phrase from the first plurality of words or phrases for which a frequency value information was determined for the particular content channel. At 1170, a computing device (e.g., the computing device 110 or the keyword engine 170) may determine a next word or phrase of the first plurality of words or phrases for which a frequency value information was determined for the particular content channel for analysis. For example, the keyword engine 170 may determine if one or more words or phrases of the first plurality of words or phrases for which a frequency value information was determined for the content channel have not yet been analyzed and may select the next word or phrase for analysis and the method may be followed back to 1110. The method of FIG. 11 may be completed for each of the first plurality of words or phrases for which a frequency value information was determined for each of the plurality of content channels (e.g., the content channels predetermined for review or the content channels selected by the user for review).

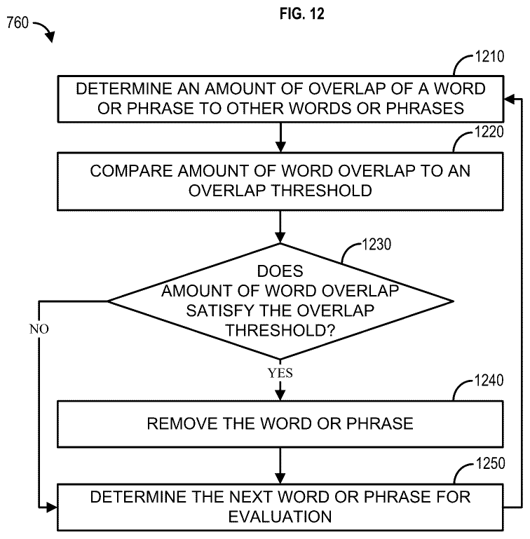

FIG. 12 shows a flowchart of another example method 760 for removing words or phrases identified in the content from analysis. For example, a computing device (e.g., the computing device 110 or the keyword engine 170) may compare a word or phrase of the first plurality of words or phrases of the content for the content channel and for which frequency value information was determined to one or more (e.g., each other) word or phrase of the first plurality of words or phrases of the content for the content channel and for which frequency value information was determined to determine an amount of overlap between the words and phrases. A certain amount of overlap between words and/or phrases may indicate that the overlapping words and/or phrases are related to the same subject matter. For example, the keyword engine 170 may determine if one of the overlapping words and/or phrases should be removed from the first plurality of words or phrases of the content for the content channel to reduce substantially duplicate matter from being displayed in separate portions of an output of the first plurality of words or phrases of the content for the content channel.

At 1210, a computing device (e.g., the computing device 110 or the keyword engine 170) may determine an amount of overlap of a word or phrase to other words or phrases. For example, the keyword engine 170 may compare a word or phrase of the first plurality of words or phrases of the content segments of the content for a particular content channel to one or more (e.g. each) other words or phrases in the first plurality of words or phrases of the content segments of the content for a particular content channel to determine the amount of overlap (e.g., a percentage of overlap) for the word or phrase. For example, given the phrase “hot stove,” the keyword engine 170 may compare “hot stove” to each other word or phrase of the first plurality of words or phrases to determine an amount of overlap. For example, keyword engine 170 may compare “hot stove” to the phrase “hot stove league” and determine a 100 percent overlap. For example, the keyword engine 170 may compare “hot stove” to the word “hot” and determine a 50 percent overlap. For example, the keyword engine 170 may compare “hot stove” to the phrase “home run trot” and determine a 0 percent overlap.

At 1220, a computing device (e.g., the computing device 110 or the keyword engine 170) may compare the amount of overlap, for the word or phrase to another one of the first plurality of words or phrases, to an overlap threshold. The overlap threshold may be a predetermined value or a user-selectable value. The overlap threshold can be any value greater than or equal to zero (e.g., between 0 percent-100 percent). For example, the overlap threshold may be value greater than or equal to 50 percent (e.g., 50 percent, 66 percent, 75 percent, etc.). Providing an overlap threshold with a value of 50 percent or greater may capture only those words or phrases that substantially similar in the content, which may indicate they are directed to the same subject matter. For example, the keyword engine 170 may compare the amount of overlap, for the word or phrase to another one of the first plurality of words or phrases, to the overlap threshold to determine if the amount of overlap satisfies the overlap threshold. For example, the amount of overlap may satisfy the overlap threshold if the amount of overlap is greater than or greater than or equal to the overlap threshold. At 1230, a computing device (e.g., the computing device 110 or the keyword engine 170) may determine if the amount of overlap, for the word or phrase to another one of the first plurality of words or phrases, satisfies the overlap threshold. If the amount of overlap satisfies the overlap threshold (e.g., the amount of overlap is greater than or greater than or equal to the overlap threshold), then the YES branch may be followed to 1240. If the amount of overlap for the word or phrase does not satisfy the overlap threshold (e.g., the amount of overlap is less than or less than or equal to the overlap threshold) then the NO branch may be followed to 1250. The comparison and determination of 1220-1230 may be completed for each comparison of the word or phrase to each other word or phrase in the first plurality of words or phrases for the content segments of the content for the content channel during the time period being analyzed.

At 1240, a computing device (e.g., the computing device 110 or the keyword engine 170) may remove the word or phrase from the first plurality of words or phrases for which a frequency value information was determined for the particular content channel. At 1250, a computing device (e.g., the computing device 110 or the keyword engine 170) may determine a next word or phrase of the first plurality of words or phrases for which a frequency value information was determined for the particular content channel for analysis. For example, the keyword engine 170 may determine if one or more words or phrases of the first plurality of words or phrases for which a frequency value information was determined for the content channel have not yet been analyzed and may select the next word or phrase for analysis and the method may be followed back to 1210. The method of FIG. 12 may be completed for each of the first plurality of words or phrases for which a frequency value information was determined for each of the plurality of content channels (e.g., the content channels predetermined for review or the content channels selected by the user for review).

Returning to FIG. 7, at 770, a computing device (e.g., the computing device 110 or the keyword engine 170) may modify the frequency value information for one or more of the first plurality of words or phrases for the content segments of the content of the particular content channel for the evaluated time period. For example, the keyword engine 170 may modify the frequency value information based on the number of words in the respective word or phrase of the first plurality of words or phrases. For example, the keyword engine 170 may increase the frequency value information for a phrase that includes more than one word. For example, the keyword engine 170 may increase the frequency value information for a phrase that includes more than one word exponentially over the frequency value information for a single word. For example, the modification of the frequency value information based on the number of words in the word or phrase may be calculated as follows:

modified frequency value information=frequency_value_information\hat{ }(2*(word_count−1))), where frequency_value_information is the original frequency value information for the phrase and word_count equals the number of words in the phrase.

In addition, or in the alternative, the keyword engine 170 may modify the frequency value information based on the popularity of the one or more shows or programs within the content from which the content segment associated with the particular word or phrase was received. For example, the keyword engine 170 may increase (or increase by a greater amount) the frequency value information for words or phrases in the first plurality of words or phrases that are from more popular programs in the content as compared to less popular programs in the content. For example, the modification of the frequency value information based on the popularity of the shows from which the word or phrase came from and the number of words in the word or phrase may be calculated as follows:

modified frequency value information=Σ(program_popularity) (frequency_value_information\hat{ }(2*(word_count−1))),

where program_popularity may be the number of viewers watching or user devices tuned in to the program and/or the aggregated number of minutes that the program was watched or that user devices were tuned in to the program; frequency_value_information is the original frequency value information for the phrase and word_count equals the number of words in the phrase.

At 780, a computing device (e.g., the computing device 110 or the keyword engine 170 may determine if there is additional content (e.g., another source content item (e.g., from one or more other content channels)) to evaluate for frequency value information. For example, the keyword engine 170 may determine the frequency value information for each content channel providing content, a portion of the content channels providing content (e.g., based on the type of content channel (e.g., news channels (which may be separated into national news channels and local news channels), sports channels, weather channels, movie channels, comedy channels, music channels, etc.), or just one content channel providing content. For example, the determination of which content channels to evaluate may be predetermined or set based on user preferences received from the user device 190. For example, if the computing device 110 determines that additional content is to be evaluated, the YES branch may be followed to 710. If the computing device 110 determines that there is not additional content to be evaluated, the NO branch may be followed to 790.

At 790, a computing device (e.g., the computing device 110 or the keyword engine 170) may send or otherwise present the results indicating the frequency value information for all or the remaining portion (e.g., based on removal of a portion of the first plurality of words or phrases) of the first plurality of words or phrases for the content segments of the content for each of the content channels to be displayed. For example, the computing device 110 may send the results indicating the frequency value information to the user device 190 via the network 104. For example, the results may be sent to the user device 190 in response to a request received from the user device 190 for the frequency value information for one or more of the content channels. The request may include the content channel or channels (or content sources) that the user associated with the user device 190 wants to receive associated frequency value information. The request may also include a time period (e.g., a selection of hours, days, or weeks) for which the user associated with the user device 190 wants to receive associated frequency value information. If no time period is provided in the request, the computing device 110 may revert to one or more default time periods (e.g., one day, two days, three days, one week, two weeks, one month, or any other time period between 1 hour and 1 year). The request may also include a user identifier (e.g., a user name, user network address, user device ID or another form of unique identifier). Based on the selected content channels and/or sources and the selected time period, the computing device 110 may determine the frequency value information for the requested channels during the request time period as described above and may present those results to the user via presenting or displaying the results on the user device 190. For example, the results may be presented in the form of a table or any other format.

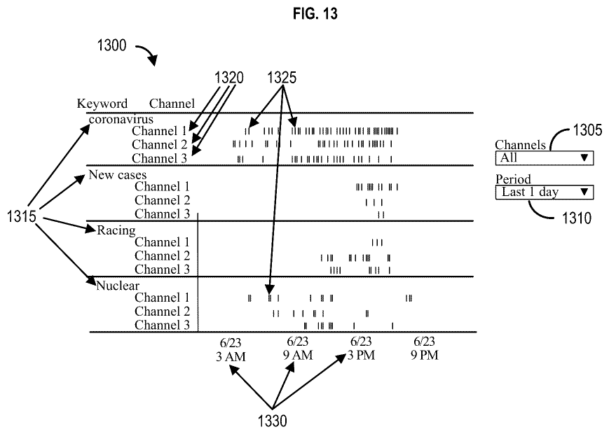

FIG. 13 shows an example output 1300 of the analysis of the content. For example, the request from the user device 190 may include the content channels (or other content sources) for which frequency value information is requested (e.g., the specific content channels or based on the primary content provided by content channels (e.g., national news, weather, local news, sports, movies, comedy, music, etc.)) to identify keywords that are being repeated a significant quantity of times by the one or more requested content channels and the quantity of times they are repeating those keywords. The content channels may be selected by a user via a channel drop-down box 1305 or another method. The request from the user device 190 may also include the time period to analyze the content of the selected content channels for (e.g., 1 day of content, 2 days of content, 3 days of content or any other time period between and including 1 hour to 1 year). For example, the time period may be selected by a user via a time period drop-down box 1310 or another method. In another example, the time period may be pre-set or predetermined by the computing device 110.

The keyword engine 170 or another portion of the computing device 110 may receive the request and generate the output (e.g., the results indicating the frequency value information for at least a portion of the first plurality of words or phrases that make up the keywords for one or more content channels based on the content received). For example, the results may be in the form of the table 1300. For example, the table 1300 may include at least a portion of the first plurality of words or phrases, individually listed as a keyword or phrase 1315 along one axis of the table and the time period analyzed 1330 along another axis of the table. For example, each of the at least a portion of the first plurality of words or phrases, presented as keywords or phrases 1315 may further include the listing of one or more of the content channels 1320 evaluated. For example, the listing of content channels 1320 may include all of the content channels evaluated for frequency value information. In another example, the listing of content channels 1320 may include only a portion of the content channels evaluated (e.g., a predetermined quantity (e.g., any quantity between 1-10 content channels) of content channels ordered based on the frequency value information for the content channel for the particular word or phrase of the first plurality of words or phrases). For example, the keyword engine 170 may organize the evaluated content channels based on the frequency value information for each content channel for a particular word or phrase of the remaining portion of the first plurality of words or phrases. For example, the keyword engine 170 may organize the evaluated content channels from highest frequency value information to lowest frequency value information for the time period being analyzed for the particular word or phrase.

The table 1300 may also include an indication 1325 of each matching word or phrase of the first plurality of words or phrases (e.g., keyword) 1315 for the content of the particular content channel. For example, the indication 1325 may be aligned on the table 1300 based on the time the particular word or phrase 1315 occurred in the text for the particular content channel 1320. For example, the indication 1325 may be a mark (e.g., line, dot, etc.) on the table 1300. For example, the indication 1325 may be a thumbnail of the content segment or a plurality of content segments that include the content segment with the particular word or phrase in the text. For example, the indication 1325 may include a link to the content segment (or a plurality of content segments that include the content segment with particular word or phrase in the text (e.g., a URL of the content segment, an identifier of the content segment (e.g., content title and segment number)) for selection via the user device 190 and display (e.g., playing) of the content segment (or plurality of content segments including the content segment with the particular word or phrase in text) on the user device 190.

FIG. 14 shows another example output 1400 of the analysis of the content. For example, a request from the user device 190 may include one or multiple content channels for which frequency value information is requested (e.g., the specific content channels or based on the primary content provided by content channels (e.g., national news, weather, local news, sports, movies, comedy, music, etc.)) to identify keywords that are being repeated a significant quantity of times by the one or more content channels and the quantity of times they are repeating those keywords. The content channels may be selected by a user via a channel drop-down box (not shown) or another method. The request from the user device 190 may also include the time period to analyze the content of the selected content channels for (e.g., 1 day of content, 2 days of content, 3 days of content or any other time period between and including 1 hour to 1 year). For example, the time period may be selected by a user via a time period drop-down box (not shown) or another method. In another example, the time period may be pre-set or predetermined by the computing device 110.

The keyword engine 170 or another portion of the computing device 110 may receive the request and generate the output (e.g., for at least a portion of the first plurality of words or phrases, one or more thumbnails of a portion of the content that include the segment of the content associated with the word or phrase in the first plurality of words or phrases). For example, the thumbnails may be organized based on content channel (e.g., for at least a portion of the first plurality of words or phrases, a different row of thumbnails for each content channel of the plurality of content channels associated with the plurality of source content items 102. For example, the thumbnails associated with each respective content channel may be further organized temporally based on when they were provided by the content channel or received by the computing device 110. For example, at least a portion of the first plurality of words or phrases may be organized (e.g., ordered) based on the frequency value information for the word or phrase and the thumbnails that include the particular word or phrase may be ordered temporally irrespective of the content channel associated with portion of the content associated with the particular thumbnail.

The output 1400 may be presented in the form of a table 1405, the table 1405 may include an indication of the word or phrase 1410 of the first plurality of words or phrases for which frequency value information was determined. The table 1405 may also include a plurality of thumbnails 1415 indicated portions of the content for selection and viewing. While FIG. 14 shows thumbnails 1415 as an example for selecting a portion of the content for viewing, this is for example purposes only as the portion of the content may be presented in another manner, such as a listing, table entry, GIF, or any other format now know or hereafter developed.

Each thumbnail 1415 may include descriptive information for the portion of the content. For example, the thumbnail 1415 may include a run-time indicator 1420 indicating the length or run-time of the portion of the content associated with the particular thumbnail 1415. For example, the thumbnail 1415 may include a graphical representation 1425. The graphical representation may be a still picture taken from the portion of the content associated with the thumbnail 1415 or a picture indicating the type of content in the portion of the content. For example, the thumbnail 1415 may include the program name 1430 indicating the program on which the portion of the content associated with the thumbnail 1415 aired. For example, the thumbnail 1415 may include the content channel name 1435 indicating the content channel on which the portion of the content associated with the thumbnail 1415 aired.

A user may select the thumbnail 1415, which may be associated with a URL or other linking information to the portion of the content being requested. Based on the user selection, a computing device (e.g., the computing device 110) may retrieved the requested portion of the content and send the requested portion of the content to the user device 190 (e.g., via the network 104) for display at the user device 190.

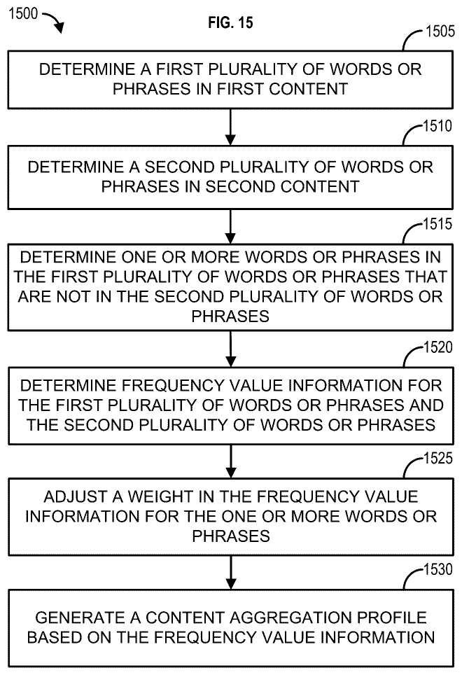

FIG. 15 shows a flowchart of an example method 1500 for analyzing word and/or phrase usage in a plurality of content. For example, the computing device 110 and/or the keyword engine 170 may receive a plurality of source content items 102 for a plurality of content channels and may evaluate text (e.g., detected text or closed-captioning data) within or associated with the content to determine the frequency with which words and/or phrases are used within the content for each content channel over a predetermined or user-selected period of time. Furthermore, additional weight (and thus a higher priority or frequency score (e.g., frequency value information) may be applied to words and/or phrases that are identified in more recent content and not identified in less recent content.

At 1505, the computing device (e.g., the computing device 110 and/or the keyword engine 170) may determine a first plurality of words or phrases in first content. For example, the keyword engine 170 may determine the first plurality of words or phrases in the first content for a time period of the first content (e.g., a time period when the first content is available to be viewed, either via access by or transmitted to users, etc.). For example, the time period may be a predetermined time period or a user-selected time period. For example, the time period may be any amount of time (e.g., the prior 24 hours, 2 days, 3 days or any other time period between and including 1 hour to 1 year).

For example, the computing device 110 may receive the first content from one of the plurality of source content items 102. For example, the first content may be received from a first content source. The first content may comprise audio content, video content, or a combination of audio and video content. The first content may be live content (e.g., a linear content stream) or VOD content. For example, the computing device 110 may receive each of the one or more source content items 102 from an external source (e.g., a stream capture source, a data storage device, a media server, etc.) via a wired or wireless network connection, such as the network 104 or another network (not shown). For example, the first content may be from one of a plurality of content channels (e.g., Channel 1, Channel 2, Channel 3, etc.).

The segmenter 131 may separate the first content 102 into a plurality of content segments. Each content segment for the first content may include a portion of the first content. For example, the segmenter 131 of the packager 130 may separate the first content into sequential content segments in chronological order of the first content. For example, each content segment may include a time value indicating the time the content segment was created (e.g., segmented) or the time the content segment is intended to be output (e.g., via broadcast, unicast, multicast, etc.) to one or more user devices 190. Further, if the first content includes separate video and audio content, the segmenter 131 may generate the content segments such that the separate content segments of video and audio of the first content are timecode aligned.

The computing device (e.g., the computing device 110 and/or captions module 113 of the segment engine 111) may determine the text (e.g., detected text data or closed captioning data) associated with each of the plurality of content segments. For example, text associated with each of the content segments may include closed-captioning data, text detected within the content, dialogue provided as text for the content, summaries of the content, descriptions of the content, third-party descriptions of the content, social media descriptions of the content, and the like. The closed-captioning data, or other available text data, may include a text string of words associated with the content segment (e.g., the dialogue occurring during the content segment or a subsequent content segment, a description of a scene occurring during that content segment or a subsequent content segment, a description of audio (e.g., music, sounds) occurring during that content segment or a subsequent content segment, etc. The captions module 113 of the segment engine 111 may parse the content segment and identify and/or retrieve the text associated with (e.g., included with) the content segment. For example, the captions module 113 may associate the text with a time value. The time value may be the time the content segment was created, the time the text was parsed from the content segment, or the time the content segment is intended to be output. For example, the first plurality of words or phrases in the first content may be a subset of the plurality of words in the text.

The keyword engine 170 may evaluate the words within the text associated with each content segment and include all or a portion of the words of each respective content segment as part of the first plurality of words or phrases associated with the text for the particular content segment. For example, the keyword engine 170 may modify or remove one or more of the words within the text for each content segment (e.g., such as discussed in FIG. 7, 760 and FIGS. 8-12 and incorporated herein) and generate a listing of the first plurality of words or phrases based on the remaining portion of the unmodified and/or modified one or more words or phrases of the plurality of content segments for the first content.

At 1510, the computing device (e.g., the computing device 110 and/or the keyword engine 170) may determine a second plurality of words or phrases in second content. For example, the keyword engine 170 may determine the second plurality of words or phrases in the second content for a prior time period of the second content. For example, the prior time period may be a predetermined time period or a user-selectable time period. The prior time period may be one or more periods of time that occurs chronologically prior to the time period of 1505 (e.g., the time period is closer to a current time period than the prior time period is to the current time period) and does not include the time period. For example, the prior time period may be one or more periods of time that occur immediately chronologically prior to the time period of 1505 and does not include the time period. For example, the prior time period may be any amount of time (e.g., the prior 24 hours, 2 days, 3 days, 1 week, 2 weeks, 3 weeks, 1 month, 2 months, 3 months or any other time period between and including 1 hour to 1 year). For example, the time period may be shorter or a lesser amount of time than the prior time period. For example, the time period may be longer or a greater amount of time than the prior time period.

For example, the computing device 110 may receive the second content from one of the plurality of sources (e.g., content streamers) of content items 102. For example, the second content may be received from the first content source or a second content source different from the first content source. The second content may comprise audio content, video content, or a combination of audio and video content. The second content may be live content (e.g., a linear content stream) or VOD content. For example, the second content may be from the same or a different content channel of the plurality of content channels (e.g., Channel 1, Channel 2, Channel 3, etc.) as the first content. For example, the computing device (e.g., the computing device 110 and/or the keyword engine 170) may determine the second plurality of words or phrases in the second content in substantially the same manner as described above in 1505 and incorporated herein. For example, the second plurality of words or phrases in the first content may be a subset of the plurality of words in the text associated with the second content.

At 1515, the computing device (e.g., the computing device 110 and/or the keyword engine 170) may determine one or more words or phrases in the first plurality of words or phrases that are not in the second plurality of words or phrases. For example, the keyword engine 170 may compare each of the words or phrases in the first plurality of words or phrases to each of the words or phrases in the second plurality of words or phrases to determine if a match exists.

For example, prior to the comparison, the keyword engine 170 or another portion of the computing device 110 may modify or normalize one or more of the first plurality of words or phrases and/or the second plurality of words or phrases. For example, in modifying or normalizing the one or more of the first plurality of words or phrases and/or the second plurality of words or phrases, the keyword engine 170 may modify any plural form of a word into a singular form of that word, may modify any possessive form of a word into a non-possessive form of the word, and/or may modify verbs within the one or more of the first plurality of words or phrases and/or the second plurality of words or phrases from past or future tense to present tense, etc.

The keyword engine 170 may identify the one or more words in the first plurality of words or phrases that don't have a corresponding match in the second plurality of words or phrases based on the comparison. The keyword engine 170 may store (e.g., in the text data storage devices 139, 171) or otherwise indicate these one or more words or phrases in the first plurality of words or phrases.

At 1520, the computing device (e.g., the computing device 110 and/or the keyword engine 170) may determine frequency value information for at least one word or phrase of the first plurality of words or phrases and the second plurality of words or phrases. For example, the keyword engine 170 may determine frequency value information for a portion of the words or phrases in the first plurality of words or phrases and the second plurality of words or phrases that have not been removed, as described above. For example, the keyword engine 170 may determine, as the frequency value information, a quantity of each of the first plurality of words or phrases and the second plurality of words or phrases for the combined time period and the prior time period. For example, if a word (e.g. Congress) is in both the first plurality of words or phrases and the second plurality of words or phrases, the keyword engine 170 may determine the quantity of times that the word (e.g., Congress) is used during both the time period and the prior time period when determining the frequency value information for the particular word (e.g., Congress).

The quantity may represent the frequency value information for the particular word or phrase. For example, the keyword engine 170 may compare each word or phrase determined during the time period and prior time period (e.g., the first plurality of words or phrases and second plurality of words or phrases for each content segment of the content and for the content channel) to each other word or phrase determined during that time period and the prior time period from the content for that content channel to determine if any of the words or phrases match. For example, the keyword engine 170 may determine the quantity of times that the word “image” 840B occurred in the content for the content channel for the time period and the prior time period. Similarly, the keyword engine 170 may determine the quantity of times that the phrase “people rally” 850C occurred in the content for the content channel for the time period and the prior time period.

For example, when the keyword engine 170 determines a match of a word or phrase of the first plurality of words or phrases to another word or phrase determined during that time period or the prior time period from the content for that content channel, the keyword engine 170 may store an indication of the match (e.g., may increment a counter variable for the particular word or phrase). The keyword engine 170 may also store a copy of or an indication of the content segment of the content that included the matching word or phrase (e.g., a URL of the content segment, an identifier of the content segment (e.g., content title and segment number), etc.). The keyword engine 170 may associate the copy or indication of the content segment with the indication of the match, such that, in response to a user selecting (e.g., via user device 190) an indication of a word or phrase match for one of the first plurality of words or phrases or the second plurality of words or phrases for a content channel (see FIG. 11), the computing device 110 or the keyword engine 170 will retrieve and present for display a copy of the content segment (or a plurality of content segments that include the content segment with the selected matching word or phrase) for viewing by the user via the user device 190.

The keyword engine 170 may determine the frequency value information for each word or phrase of the first plurality of words or phrases and the second plurality of words or phrases for each content segment of the content and for each content channel (e.g., Channel 1, Channel 2, Channel 3, etc.) from which the content was received for the time period and the prior time period.

The keyword engine 170 may sum all of the instances of the words and/or phrases of the first plurality of words or phrases and the second plurality of words or phrases for the particular content channel and for the combined time period and prior time period of the content provided by the particular content channel (e.g., 1 day of content, 2 days of content, 3 days of content, 1 month of total content, or any other time period between and including 1 hour to 1 year) to determine the frequency value information for each word and/or phrase. For example, the keyword engine 170 may sum up the quantity of times that the word “image” 850B is in first plurality of words or phrases and the second plurality of words or phrases for all of the content segments of the content of the content channel for the time period and the prior time period. The sum of all of the instances of a word or phrase in the first plurality of words or phrase and the second plurality of words or phrases in the content for the content channel for the time period and the prior time period may represent the frequency value information for that particular word or phrase for that content channel. For example, frequency value information may be included for words or phrases that occur in both the first plurality of words or phrases and the second plurality of words or phrase and for words or phrases that are only in one of the first plurality of words or phrases or the second plurality of words or phrases.

For example, each frequency value information for each word or phrase may also include a weight or weight adjustment. For example, the weight for frequency value information for those words or phrases that are in both the first plurality of words or phrases and the second plurality of words or phrases or are in just the second plurality of words or phrases may be one or may not include a weight. At 1525, the computing device (e.g., the computing device 110 and/or the keyword engine 170) may adjust a weight or apply a weight (e.g., a multiplication factor) to the frequency value information for the one or more words phrases of 1515 determined to be in the first plurality of words or phrases but not in the second plurality of words or phrases. The weight or weighting factor may increase the quantity of the frequency value information for these one or more words. For example, words or phrases that are only indicated in the time period but not the prior time period may indicate that those words or phrases are indicative of an event that has recently occurred, which may be why that word or phrase was not in the second plurality of words or phrases in the prior time period. The weight can be any amount between 1.01 to 1000. The weight can be multiplied by the quantity of the frequency value information for the one or more words determined in 1515 to result in the frequency value information (e.g., modified or adjusted frequency value information) for those one or more words.

At 1530, the computing device (e.g., the computing device 110 and/or the keyword engine 170) may generate a content aggregation profile based on the frequency value information for the words or phrases identified in the first plurality of words or phrases and/or the second plurality of words or phrases. For example, the content aggregation profile may comprise all or one or more of at least a portion of the words or phrases from the first plurality of words or phrases and/or the second plurality of words or phrases and the results indicating the frequency value information for all or one or more of at least a portion of the words or phrases in the first plurality of words or phrases and/or the second plurality of words or phrases for the content segments of the content for each of the content channels to be displayed. For example, the computing device 110 may generate the results indicating the frequency value information for each word or phrase (e.g., a portion of which may have been modified by a weight in 1525). For example, the keyword engine 170 may organize or order all or at least a portion of the words or phrases from the first plurality of words or phrases and/or the second plurality of words or phrases based on the frequency value information for each word or phrase for each content channel. For example, the keyword engine 170 may order the words or phrases from highest-to-lowest frequency value information with the word or phrase with the highest frequency value information for a particular content channel being positioned at the top of a listing or table of the words or phrases and the word or phrase with the lowest frequency value information for a particular content channel being positioned at the bottom of the listing or table of the words or phrases for the content channel for the time period and the prior time period.

The content aggregation profile may also include each content segment (or an indication of the content segment) comprising the particular word or phrase in the table. For example, each content segment (or its indication) may be positioned along the same row as the particular word or phrase and its frequency value information. For example, each content segment (or an indication of the content segment) may be otherwise associated with the word in the table included in the particular content segment (e.g., hyperlink, URL, mark, line, dot, etc.). For example, each content segment may be at least a portion of one of the first content or the second content. For example, the table may be substantially as described with regard to the table 1300 of FIG. 13 or the table 1400 of FIG. 14. The table of the content aggregation profile may include at least a portion of the first plurality and/or second plurality of words or phrases, individually listed as a word or phrase along one axis of the table and the time period and/or content segments (or indications of content segments) associated with (e.g., that include) the particular word or phrase along another axis of the table.

A computing device (e.g., the computing device 110 or the keyword engine 170) may send or otherwise present the content aggregation profile to the user device 190 via the network 104. For example, the content aggregation profile may be sent to the user device 190 in response to a request received from the user device 190 for the frequency value information for one or more of the content channels. The request may include the content channel or channels (or content sources) that the user associated with the user device 190 wants to receive associated frequency value information. The request may also include a requested time period (e.g., a selection of hours, days, or weeks) (e.g., a combination of the time period and the prior time period) for which the user associated with the user device 190 wants to receive associated frequency value information. If no requested time period is provided in the request, the computing device 110 may revert to one or more default time periods (e.g., one day, two days, three days, one week, two weeks, one month, or any other time period between 1 hour and 1 year). The request may also include a user identifier (e.g., a user name, user network address, user device ID or another form of unique identifier). Based on the selected content channels and/or sources and the requested or predetermined time period, the computing device 110 may determine the frequency value information for the requested channels during the requested time period as described above and may present those results to the user device 190, in the form of the content aggregation profile, via presenting or displaying the profile on the user device 190. For example, the results may be presented in the form of a table or any other format.

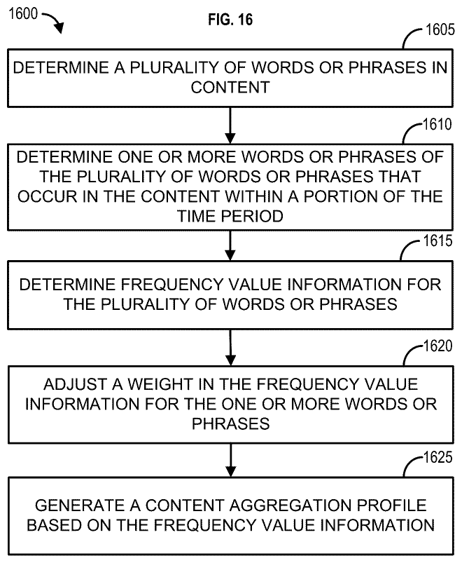

FIG. 16 shows a flowchart of another example method 1600 for analyzing word and/or phrase usage in content. For example, the computing device 110 and/or the keyword engine 170 may receive a plurality of source content items for a plurality of content channels and may evaluate text (e.g., detected text data or closed-captioning data) within the content to determine the frequency with which words and/or phrases are used within the content for each content channel over a predetermined or user-selected period of time. Furthermore, additional weight (and thus a higher priority or frequency score (e.g., frequency value information) may be applied to words and/or phrases that are identified in more recent content.

At 1605, the computing device (e.g., the computing device 110 and/or the keyword engine 170) may determine a plurality of words or phrases in content. For example, the keyword engine 170 may determine the plurality of words or phrases in the content for a time period of the content. For example, time period may be a predetermined time period or a user-selected time period. For example, the time period may be any amount of time (e.g., 1 day, 2 days, 3 days, 1 week, 2 weeks, 3 weeks, 1 month, 3 months or any other time period between and including 1 hour to 1 year).

For example, the computing device 110 may receive the content from one of the plurality of source content items 102. For example, the content may be received from a content source. The content may comprise audio content, video content, or a combination of audio and video content. The content may be live content (e.g., a linear content stream) or VOD content. For example, the computing device 110 may receive each of the one or more source content items 102 from an external source (e.g., a stream capture source, a data storage device, a media server, etc.) via a wired or wireless network connection, such as the network 104 or another network (not shown). For example, the content may be from one of a plurality of content channels (e.g., Channel 1, Channel 2, Channel 3, etc.).

The segmenter 131 may separate the content into a plurality of content segments. Each content segment for the content may include a portion of the content. For example, the segmenter 131 of the packager 130 may separate the content into sequential content segments in chronological order of the content. For example, each content segment may include a time value indicating the time the content segment was created (e.g., segmented) or the time the content segment is intended to be output (e.g., via broadcast, unicast, multicast, etc.) to one or more user devices 190. Further, if the content includes separate video and audio content, the segmenter 131 may generate the content segments such that the separate content segments of video and audio of the content are timecode aligned.

The computing device (e.g., the computing device 110 and/or captions module 113 of the segment engine 111) may determine the text associated with each of the plurality of content segments of the content. For example, text associated with each content segment may include closed-captioning data, text detected within the content, dialogue provided as text for the content, summaries of the content, descriptions of the content, third-party descriptions of the content, social media descriptions of the content, and the like. The text may include a text string of words associated with the content segment. The captions module 113 of the segment engine 111 may parse the content segment and identify and/or retrieve the text associated with (e.g., included with) the content segment. For example, the captions module 113 may associate the text with a time value. The time value may be the time the content segment was created, the time the text was parsed from the content segment, or the time the content segment is intended to be output. For example, the plurality of words or phrases in the content may be a subset of the plurality of words in the text.

The keyword engine 170 may evaluate the words within the text associated with each content segment and include all or a portion of the words of each respective content segment as part of the plurality of words or phrases associated with the text for the particular content segment. For example, the keyword engine 170 may modify or remove one or more of the words within the text for each content segment (e.g., such as discussed in FIG. 7, 760 and FIGS. 8-12 and incorporated herein) and generate a listing of the plurality of words or phrases based on the remaining portion of the unmodified and/or modified one or more words or phrases of the plurality of content segments for the content.

At 1610, the computing device (e.g., the computing device 110 and/or the keyword engine 170) may determine one or more words or phrases in the plurality of words or phrases that occur within a portion of the time period. For example, the portion of the time period may be the most recent portion of the time period in with reference to the current time. For example, the portion of the period of time may be any percentage or portion of the period of time. For example, the portion of the period of time may be predetermined amount of time or a user-selectable amount of time. For example, the portion of the period of may be 1 day, 2 days, 3 days, 1 week, or any other amount of time between 1 hour and 1 year. For example, the time period may be the last 30 days of the content and the portion of the time period may be 3 days (e.g., the most recent 3 days) of the content.

The keyword engine 170 may determine the one or more words or phrases of the plurality of words or phrases that occur in the content within a portion of the time period. For example, the keyword engine may evaluate the time value associated with the text for the plurality of words or phrases to determine the one or more words or phrases that occur in the content within the portion of the time period. For example, if the time value associated with the text falls within the portion of the time period, then the keyword engine 170 may determine that the words or phrases within that text falls within the one or more words or phrases of the plurality of words or phrases that occur in the content within the portion of the time period. For example, if the time value is two days and nine hours ago and the portion of the time period is the last three days, then the keyword engine 170 may determine that the words or phrases within that text falls within the one or more words or phrases of the plurality of words or phrases that occur in the content within the portion of the time period. The keyword engine 170 may store (e.g., in the text data storage devices 139, 171) or otherwise indicate these one or more words or phrases in the plurality of words or phrases.

At 1615, the computing device (e.g., the computing device 110 and/or the keyword engine 170) may determine frequency value information for at least one word or phrase of the plurality of words or phrases. For example, the keyword engine 170 may determine frequency value information for a portion of the words or phrases in the plurality of words or phrases that have not been removed, as described above. For example, the keyword engine 170 may determine, as the frequency value information, a quantity of each of the plurality of words or phrases for the time period.

The quantity of times that the word or phrase occurs during the time period may represent the frequency value information for the particular word or phrase. For example, the keyword engine 170 may compare each word or phrase determined during the time period (e.g., all or a portion of the plurality of words or phrases for each content segment of the content and for the content channel) to each other word or phrase determined during that time period from the content for that content channel to determine if any of the words or phrases match. For example, the keyword engine 170 may determine the quantity of times that the word “image” 840B occurred in the content for the content channel for the time period.

For example, when the keyword engine 170 determines a match of a word or phrase of the plurality of words or phrases to another word or phrase determined during that time period from the content for that content channel, the keyword engine 170 may store an indication of the match (e.g., may increment a counter variable for the particular word or phrase). The keyword engine 170 may also store a copy of or an indication of the content segment of the content that included the matching word or phrase (e.g., a URL of the content segment, an identifier of the content segment (e.g., content title and segment number), etc.). The keyword engine 170 may associate the copy or indication of the content segment with the indication of the match, such that, in response to a user selecting (e.g., via a request from the user device 190) an indication of a word or phrase match for one of the plurality of words or phrases for a content channel (see FIG. 14), the computing device 110 or the keyword engine 170 will retrieve and present for display a copy of the content segment (or a plurality of content segments that include the content segment with the selected matching word or phrase) for viewing by the user via the user device 190.

The keyword engine 170 may determine the frequency value information for each word or phrase of the plurality of words or phrases for each content segment of the content and for each content channel (e.g., Channel 1, Channel 2, Channel 3, etc.) from which the content was received for the time period.

The keyword engine 170 may sum all of the instances of the words and/or phrases of the plurality of words or phrases for the particular content channel and for the time period of the content provided by the particular content channel (e.g., 1 day of content, 2 days of content, 3 days of content, 1 month of total content, or any other time period between and including 1 hour to 1 year) to determine the frequency value information for each word and/or phrase. For example, the keyword engine 170 may sum up the quantity of times that the word “image” 850B is in plurality of words or phrases for all of the content segments of the content of the content channel for the time period. The sum of all of the instances of a word or phrase in the plurality of words or phrase in the content for the content channel for the time period may represent the frequency value information for that particular word or phrase for that content channel.

For example, each frequency value information for each word or phrase may also include a weight or weight adjustment. For example, the weight for frequency value information for those words or phrases that are within the time period but do not have any instances of the word or phrase within the portion of the time period, as discussed above, may be one or may not include a weight. At 1620, the computing device (e.g., the computing device 110 and/or the keyword engine 170) may adjust a weight or apply a weight (e.g., a multiplication factor) to the frequency value information for certain words or phrases. For example, the keyword engine 170 may adjust a weight or apply a weight to the frequency value information for the one or more words phrases of 1610 determined to be in the content (e.g., have one or more instances of the word or phrase) during the portion of the time period. For example, the keyword engine 170 may adjust a weight or apply a weight to the frequency value information for the one or more words phrases of 1610 determined to be in the content (e.g., have one or more instances of the word or phrase) during the portion of the time period but determined to not be in the content for remaining portion of the time period (e.g., the entirety of the time period other than the portion of the time period). The weight or weighting factor may increase the quantity of the frequency value information for these one or more words. For example, words or phrases that are only indicated in the content during the portion of the time period but not in the content during the remaining portion of the time period may indicate that those words or phrases are indicative of an event that has recently occurred, which may be why that word or phrase was not in the content during the remaining portion of the time period. The weight can be any amount between 1.01 to 1000. The weight can be multiplied by the quantity of the frequency value information for the one or more words determined in 1610 or further determined to be the one or more words in 1610 that also are not in the remaining portion of the time period, to result in the frequency value information (e.g., modified or adjusted frequency value information) for those one or more words.

At 1625, the computing device (e.g., the computing device 110 and/or the keyword engine 170) may generate a content aggregation profile based on the frequency value information for the words or phrases identified in the plurality of words or phrases. For example, the content aggregation profile may comprise all or one or more of at least a portion of the words or phrases from the plurality of words or phrases and the results indicating the frequency value information for all or one or more of at least a portion of the words or phrases in the plurality of words or phrases for the content segments of the content for each of the content channels to be displayed. For example, the computing device 110 may generate the results indicating the frequency value information for each word or phrase (e.g., a portion of which may have been modified by a weight in 1620). For example, the keyword engine 170 may organize or order all or at least a portion of the words or phrases from the plurality of words or phrases based on the frequency value information for each word or phrase for each content channel. For example, the keyword engine 170 may order the words or phrases from highest-to-lowest frequency value information with the word or phrase with the highest frequency value information for a particular content channel being positioned at the top of a listing or table of the words or phrases and the word or phrase with the lowest frequency value information for a particular content channel being positioned at the bottom of the listing or table of the words or phrases for the content channel for the time period.

The content aggregation profile may also include each content segment (or an indication of the content segment) comprising the particular word or phrase in the table. For example, each content segment (or its indication) may be positioned along the same row as the particular word or phrase and its frequency value information. For example, each content segment (or an indication of the content segment) may be otherwise associated with the word in the table included in the particular content segment (e.g., hyperlink, URL, mark, line, dot, etc.). For example, each content segment may be at least a portion of the content. For example, the table may be substantially as described with regard to the table 1300 of FIG. 13 or the table 1400 of FIG. 14. The table of the content aggregation profile may include at least a portion of the plurality of words or phrases, individually listed as a word or phrase along one axis of the table and the time period and/or content segments (or indications of content segments) associated with (e.g., that include) the particular word or phrase along another axis of the table.

A computing device (e.g., the computing device 110 or the keyword engine 170) may send or otherwise present the content aggregation profile to the user device 190 via the network 104 or another network. For example, the content aggregation profile may be sent to the user device 190 in response to a request received from the user device 190 for the frequency value information for one or more of the content channels. The request may include the content channel or channels (or content sources) that the user associated with the user device 190 wants to receive associated frequency value information. The request may also include a requested time period (e.g., a selection of hours, days, or weeks) for which the user associated with the user device 190 wants to receive associated frequency value information. If no requested time period is provided in the request, the computing device 110 may revert to one or more default time periods (e.g., one day, two days, three days, one week, two weeks, one month, or any other time period between 1 hour and 1 year). The request may also include a user identifier (e.g., a user name, user network address, user device ID or another form of unique identifier). Based on the selected content channels and/or sources and the requested or predetermined time period, the computing device 110 may determine the frequency value information for the requested content channels (e.g., from the content provided by those content channels) during the requested time period as described above and may present those results to the user device 190, in the form of the content aggregation profile, via presenting or displaying the profile on the user device 190.

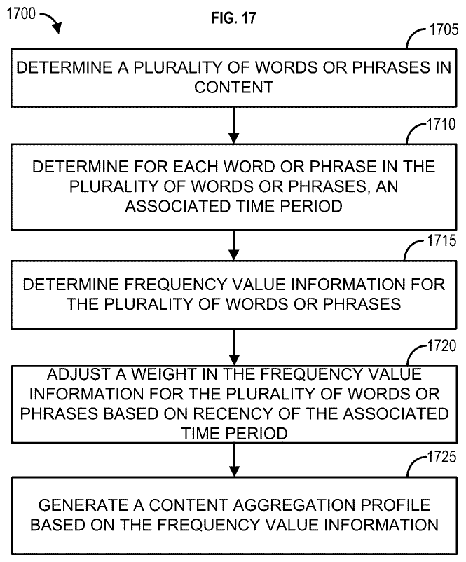

FIG. 17 shows a flowchart of another example method 1700 for analyzing word and/or phrase usage in content. For example, the computing device 110 and/or the keyword engine 170 may receive a plurality of source content for a plurality of content channels and may evaluate text (e.g., detected text data or closed-captioning data) within the content to determine the frequency with which words and/or phrases are used within the content for each content channel over a predetermined or user-selected period of time. Furthermore, additional weight (and thus a higher priority or frequency score (e.g., frequency value information) may be applied to words and/or phrases that are identified in more recent content.

At 1705, the computing device (e.g., the computing device 110 and/or the keyword engine 170) may determine a plurality of words or phrases in content. For example, the keyword engine 170 may determine the plurality of words or phrases in the content for a time period of the content. For example, time period may be a predetermined time period or a user-selected time period. For example, the time period may be any amount of time (e.g., 1 day, 2 days, 3 days, 1 week, 2 weeks, 3 weeks, 1 month, 3 months or any other time period between and including 1 hour to 1 year).

For example, the computing device 110 may receive the content from one of the plurality of source content items 102. For example, the content may be received from a content source. The content may comprise audio content, video content, or a combination of audio and video content. The content may be live content (e.g., a linear content stream) or VOD content. For example, the content may be from one of a plurality of content channels (e.g., Channel 1, Channel 2, Channel 3, etc.).

The computing device (e.g., the segmenter 131) may separate the content into a plurality of content segments. Each content segment for the content may include a portion of the content. For example, the segmenter 131 of the packager 130 may separate the content into sequential content segments in chronological order of the content. For example, each content segment may include a time value indicating the time the content segment was created (e.g., segmented) or the time the content segment is intended to be output (e.g., via broadcast, unicast, multicast, etc.) to one or more user devices 190. Further, if the content includes separate video and audio content, the segmenter 131 may generate the content segments such that the separate content segments of video and audio of the content are timecode aligned.

The computing device (e.g., the computing device 110 and/or captions module 113 of the segment engine 111) may determine the text associated with each of the plurality of content segments of the content. For example, text associated with each of the content segments may include closed-captioning data, text detected within the content, dialogue provided as text for the content, summaries of the content, descriptions of the content, third-party descriptions of the content, social media descriptions of the content, and the like. The text may include a text string of words associated with the content segment. The captions module 113 of the segment engine 111 may parse the content segment and identify and/or retrieve the text associated with (e.g., included with) the content segment. For example, the captions module 113 may associate the text with a time value. The time value may be the time the content segment was created or the time the content segment is intended to be output. For example, the plurality of words or phrases in the content may be a subset of the plurality of words in the text.

The keyword engine 170 may evaluate the words within the text for each content segment and include all or a portion of the words of each respective content segment as part of the plurality of words or phrases associated with the text associated with the particular content segment. For example, the keyword engine 170 may modify or remove one or more of the words within the text associated with each content segment (e.g., such as discussed in FIG. 7, 760 and FIGS. 8-12 and incorporated herein) and generate a listing of the plurality of words or phrases based on the remaining portion of the unmodified and/or modified one or more words or phrases of the plurality of content segments for the content. Each of the plurality of words or phrases may be associated with a respective time value associated with the text from which each respective word or phrase was identified.

At 1710, the computing device (e.g., the computing device 110 and/or the keyword engine 170) may determine, for each word or phrase of the plurality of words or phrases, an associated time period. For example, the associated time period may be the time the content segment from which the particular word or phrase of the plurality of words or phrases came from was created or the time the content segment from which the particular word or phrase of the plurality of words or phrases came from was intended to be output. For example, the keyword engine 170 may determine the time period associated with each word or phrase based on the time value. For example, the time value may be embedded in metadata associated with the particular word or phrase of the plurality of words or phrases. The keyword engine 170 may store (e.g., in the text data storage 139, 171) or otherwise indicate the time period or value associated with each word or phrase of the plurality of words or phrases.

At 1715, the computing device (e.g., the computing device 110 and/or the keyword engine 170) may determine frequency value information for all or at least one word or phrase of the plurality of words or phrases. For example, the keyword engine 170 may determine frequency value information for a portion of the words or phrases in the plurality of words or phrases that have not been removed, as described above. For example, the keyword engine 170 may determine, as the frequency value information, a quantity of each of the plurality of words or phrases in the content.

The quantity of times that the word or phrase occurs in the content may represent the frequency value information for the particular word or phrase. For example, the keyword engine 170 may compare each word or phrase determined in the content (e.g., all or a portion of the plurality of words or phrases for each content segment of the content and for the content channel) to each other word or phrase determined from the content for that content channel to determine if any of the words or phrases match. For example, the keyword engine 170 may determine the quantity of times that the word “image” 840B occurred in the content for the content channel.

For example, when the keyword engine 170 determines a match of a word or phrase of the plurality of words or phrases to another word or phrase determined from the content for that content channel, the keyword engine 170 may store an indication of the match (e.g., may increment a counter variable for the particular word or phrase). The keyword engine 170 may also store a copy of or an indication of the content segment of the content that included the matching word or phrase (e.g., a URL of the content segment, an identifier of the content segment (e.g., content title and segment number), etc.). The keyword engine 170 may associate the copy or indication of the content segment with the indication of the match, such that, in response to a user selecting (e.g., via a request from the user device 190) an indication of a word or phrase match for one of the plurality of words or phrases for a content channel (see FIG. 11), the computing device 110 or the keyword engine 170 will retrieve and present for display a copy of the content segment (or a plurality of content segments that include the content segment with the selected matching word or phrase) for viewing by the user via the user device 190.

The keyword engine 170 may determine the frequency value information for each word or phrase of the plurality of words or phrases for each content segment of the content and for each content channel (e.g., Channel 1, Channel 2, Channel 3, etc.) from which the content was received.

The keyword engine 170 may sum all of the instances of the words and/or phrases of the plurality of words or phrases for the particular content channel and for of the content provided by the particular content channel (e.g., 1 day of content, 2 days of content, 3 days of content, 1 month of total content, or any other amount of content, including 1 hour to 1 year of content) to determine the frequency value information for each word and/or phrase. For example, the keyword engine 170 may sum up the quantity of times that the word “image” 850B is in plurality of words or phrases for all of the content segments of the content of the content channel. The sum of all of the instances of a word or phrase in the plurality of words or phrase in the content for the content channel may represent the frequency value information for that particular word or phrase for that content channel.

Each frequency value information for each word or phrase may also include a weight or weight adjustment. The weight for each frequency value information may be based on the time period (e.g., time value) associated with the word or phrase associated with the frequency value information. At 1720, the computing device (e.g., the computing device 110 and/or the keyword engine 170) may adjust a weight or apply a weight (e.g., a multiplication factor) to the frequency value information for all or certain words or phrases based on the recency of the time period associated with word or phrase associated with the particular frequency value information. For example, the amount of weight may be linearly applied and may be greater for the frequency value information associated with words or phrases used most recently and least for the frequency value information associated with words or phrases used least recently. For example, the amount of weight may be logarithmic and may be greater for the frequency value information associated with words or phrases used most recently and least for the frequency value information associated with words or phrases used least recently (e.g., the longest time ago of the time values). For example, the amount of weight may be a first constant value for frequency value information associated with words or phrases having a last use during a first portion of a time period for the content and a second constant value for the frequency value information associated with words or phrases having a last use during a second portion of the time period for the content. The second constant value may be greater than the first constant value and the second portion of the time period may be more recent to the current date than the first portion of the time period for the content.

The weight or weighting factor may increase or decrease the quantity of the frequency value information for the associated words or phrases. The weight can be any amount between 0.01 to 1000. The weight can be multiplied by the quantity of the frequency value information associated with each word or phrase determined in 1715 to result in the frequency value information (e.g., modified or adjusted frequency value information) for each word or phrase.

At 1725, the computing device (e.g., the computing device 110 and/or the keyword engine 170) may generate a content aggregation profile based on the frequency value information for the words or phrases identified in the plurality of words or phrases. For example, the content aggregation profile may comprise all or one or more of at least a portion of the words or phrases from the plurality of words or phrases and the results indicating the frequency value information for all or one or more of at least a portion of the words or phrases in the plurality of words or phrases for the content segments of the content for each of the content channels to be displayed. For example, the computing device 110 may generate the results indicating the frequency value information for each word or phrase (e.g., all or a portion of which may have been modified by a weight in 1720). For example, the keyword engine 170 may organize or order all or at least a portion of the words or phrases from the plurality of words or phrases based on the frequency value information for each word or phrase for each content channel. For example, the keyword engine 170 may order the words or phrases from highest-to-lowest frequency value information with the word or phrase with the highest frequency value information for a particular content channel being positioned at the top of a listing or table of the words or phrases and the word or phrase with the lowest frequency value information for a particular content channel being positioned at the bottom of the listing or table of the words or phrases for the content channel.

The content aggregation profile may also include each content segment (or an indication of the content segment) comprising the particular word or phrase in the table. For example, each content segment (or its indication) may be positioned along the same row as the particular word or phrase and its frequency value information. For example, each content segment (or an indication of the content segment) may be otherwise associated with the word in the table included in the particular content segment (e.g., hyperlink, URL, mark, line, dot, etc.). For example, each content segment may be at least a portion of the content. For example, the table may be substantially as described with regard to the table 1300 of FIG. 13 or the table 1400 of FIG. 14. The table of the content aggregation profile may include at least a portion of the plurality of words or phrases, individually listed as a word or phrase along one axis of the table and the content segments (or indications of content segments) associated with (e.g., that include) the particular word or phrase along another axis of the table.

A computing device (e.g., the computing device 110 or the keyword engine 170) may send or otherwise present the content aggregation profile to the user device 190 via the network 104 or another network. For example, the content aggregation profile may be sent to the user device 190 in response to a request received from the user device 190 for the frequency value information for one or more of the content channels. The request may include the content channel or channels (or content sources) that the user associated with the user device 190 wants to receive associated frequency value information. The request may also include a requested time period (e.g., a selection of hours, days, or weeks) for which the user associated with the user device 190 wants to receive associated frequency value information. If no requested time period is provided in the request, the computing device 110 may revert to one or more default time periods (e.g., one day, two days, three days, one week, two weeks, one month, or any other time period between 1 hour and 1 year). The request may also include a user identifier (e.g., a user name, user network address, user device ID or another form of unique identifier). Based on the selected content channels and/or sources and the requested or predetermined time period, the computing device 110 may determine the frequency value information for the requested content channels (e.g., from the content provided by those content channels) during the requested time period as described above and may present those results to the user device 190, in the form of the content aggregation profile, via presenting or displaying the profile on the user device 190.

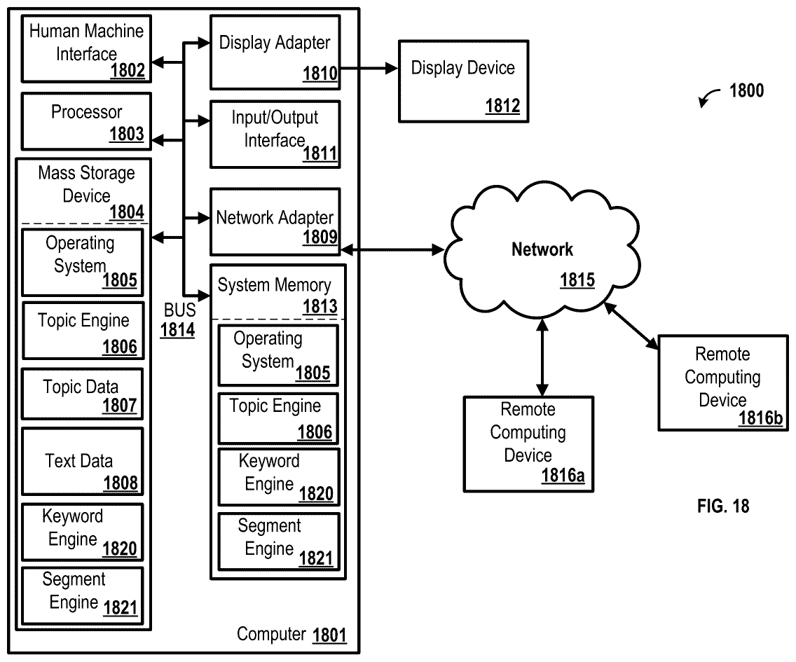

FIG. 18 shows a block diagram of an example system 1800 and computer 1801 for analyzing content. Any device/component described herein (e.g., the computing device 110, the segment engine 111, the topic engine 160, the keyword engine 170, the user device 190, etc.) may be a computer 1801 as shown in FIG. 18.

The computer 1801 may include one or more processors 1803, a system memory 1813, and a bus 1814 that couples various components of the computer 1801 including the one or more processors 1803 to the system memory 1813. In the case of multiple processors 1803, the computer 1801 may utilize parallel computing.

The bus 1814 may include one or more of several possible types of bus structures, such as a memory bus, memory controller, a peripheral bus, an accelerated graphics port, and a processor or local bus using any of a variety of bus architectures.

The computer 1801 may operate on and/or include a variety of computer-readable media (e.g., non-transitory). Computer-readable media may be any available media that is accessible by the computer 1801 and includes, non-transitory, volatile and/or non-volatile media, removable and non-removable media. The system memory 1813 has computer-readable media in the form of volatile memory, such as random access memory (RAM), and/or non-volatile memory, such as read-only memory (ROM). The system memory 1813 may store data such as topic data 1807 and text data 1808 and/or program modules such as an operating system 1805, a topic engine 1806, a keyword engine 1820 and a segment engine 1821 that are accessible to and/or are operated on by the one or more processors 1803.

The computer 1801 may also include other removable/non-removable, volatile/non-volatile computer storage media. The mass storage device 1804 may provide non-volatile storage of computer code, computer-readable instructions, data structures, program modules, and other data for the computer 1801. The mass storage device 1804 may be a hard disk, a removable magnetic disk, a removable optical disk, magnetic cassettes or other magnetic storage devices, flash memory cards, CD-ROM, digital versatile disks (DVD) or other optical storage, random access memories (RAM), read-only memories (ROM), electrically erasable programmable read-only memory (EEPROM), and the like.

Any number of program modules may be stored on the mass storage device 1804. An operating system 1805, a topic engine 1806, a keyword engine 1820, and a segment engine 1821 may be stored on the mass storage device 1804. Topic data 1807 and/or text data 1808 may also be stored on the mass storage device 1804. The topic data 1807 and/or text data 1808 may be stored in any of one or more databases known in the art. The databases may be centralized or distributed across multiple locations within the network 1815.

A user may enter commands and information into the computer 1801 via an input device (not shown). Such input devices comprise, but are not limited to, a keyboard, pointing device (e.g., a computer mouse, remote control), a microphone, a joystick, a scanner, tactile input devices such as gloves, and other body coverings, motion sensor, and the like. These and other input devices may be connected to the one or more processors 1803 via a human machine interface 1802 that is coupled to the bus 1814, but may be connected by other interface and bus structures, such as a parallel port, game port, an IEEE 1394 Port (also known as a Firewire port), a serial port, network adapter 1809, and/or a universal serial bus (USB).

A display device 1812 may also be connected to the bus 1814 via an interface, such as a display adapter 1810. It is contemplated that the computer 1801 may have more than one display adapter 1810 and the computer 1801 may have more than one display device 1812. A display device 1812 may be a monitor, an LCD (Liquid Crystal Display), light-emitting diode (LED) display, television, smart lens, smart glass, and/or a projector. In addition to the display device 1812, other output peripheral devices may comprise components such as speakers (not shown) and a printer (not shown) which may be connected to the computer 1801 via Input/Output Interface 1811. Any step and/or result of the methods may be output (or caused to be output) in any form to an output device. Such output may be any form of visual representation, including, but not limited to, textual, graphical, animation, audio, tactile, and the like. The display 1812 and computer 1801 may be part of one device, or separate devices.

The computer 1801 may operate in a networked environment using logical connections to one or more remote computing devices 1816a, 1816b. A remote computing device 1816a, 1816b may be a personal computer, computing station (e.g., workstation), portable computer (e.g., laptop, mobile phone, tablet device), smart device (e.g., smartphone, smartwatch, activity tracker, smart apparel, smart accessory), security and/or monitoring device, a server, a router, a network computer, a peer device, edge device or other common network nodes, and so on. Logical connections between the computer 1801 and a remote computing device 1816a, 1816b may be made via a network 1815, such as a local area network (LAN) and/or a general wide area network (WAN). Such network connections may be through a network adapter 1809. A network adapter 1809 may be implemented in both wired and wireless environments. Such networking environments are conventional and commonplace in dwellings, offices, enterprise-wide computer networks, intranets, and the Internet.

Application programs and other executable program components such as the operating system 1809, the topic engine 1806, the keyword engine 1820, and the segment engine 1821 are shown herein as discrete blocks, although it is recognized that such programs and components may reside at various times in different storage components of the computing device 1801, and are executed by the one or more processors 1803 of the computer 1801. An implementation of the topic engine 1806, the keyword engine 1820, and/or the segment engine 1821 may be stored on or sent across some form of computer-readable media. Any of the disclosed methods may be performed by processor-executable instructions embodied on computer-readable media.

While specific configurations have been described, it is not intended that the scope be limited to the particular configurations set forth, as the configurations herein are intended in all respects to be possible configurations rather than restrictive.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; the number or type of configurations described in the specification.

It will be apparent to those skilled in the art that various modifications and variations may be made without departing from the scope or spirit. Other configurations will be apparent to those skilled in the art from consideration of the specification and practice described herein. It is intended that the specification and described configurations be considered as exemplary only, with a true scope and spirit being indicated by the following claims.

What is claimed is:

1. A method comprising:
determining, by a computing device, a plurality of popular topics for a time period;
determining a plurality of content items associated with at least one of the plurality of popular topics;
determining an output time for each of the plurality of content items;
determining, based on the output time, a ranking order of the plurality of content items; and
causing output of an indicator of at least a portion of the plurality of content items in the ranking order.

2. The method of claim 1, wherein determining the plurality of the popular topics for the time period comprises:
receiving at least one of: a listing of most received search queries for the time period or a listing of most used hashtag topics for the time period,
wherein determining the plurality of popular topics comprises determining, based on at least one of: the listing of most received search queries for the time period or the listing of the most used hashtag topics for the time period, the plurality of popular topics.

3. The method of claim 1, wherein determining the plurality of content items associated with at least one of the plurality of popular topics comprises:
determining, a plurality of content segments for a first content item of the plurality of content items; and
determining, at least a portion of detected text of a first content segment of the plurality of content segments is associated with at least one of the plurality of popular topics.

4. The method of claim 3, wherein causing output of at least a portion the plurality of content items in the ranking order comprises causing output of an indicator of a portion of the first content item comprising the first content segment.

5. The method of claim 1, wherein the ranking order comprises ranking the plurality of content items in order from a most recent output time to a least recent output time.

6. The method of claim 1 wherein the indicator for the at least the portion of the plurality of content items comprises at least one of: a title of a content item of the plurality of content items; an image associated with the content item of the plurality of content items, or a content channel name for a content channel associated with the content item of the plurality of content items.

7. The method of claim 1, further comprising receiving, by the computing device, the plurality of content items from at least one content source.

8. The method of claim 1, wherein determining the ranking order of the plurality of content items comprises:
determining a first portion of the plurality of content items associated with a first topic of the plurality of popular topics; and
determining, based on the output time, a ranking order of the first portion of the plurality of content items.

9. The method of claim 8, wherein determining the ranking order of the first portion of the plurality of content items further comprises:
determining a portion of the first portion of the plurality of content items associated with a content source; and
determining, based on the output time, a ranking order of the portion of the first portion of the plurality of content items associated with the content source.

10. A method comprising:
receiving, by a computing device, a popular topic for a time period;
determining a plurality of content items comprising detected text associated with the popular topic;
determining an output time for each of the plurality of content items;
ranking, based on the output time, the plurality of content items.

11. The method of claim 10, further comprising causing, based on the ranking of the plurality of content items, output of an indicator of at least a portion of the plurality of content items.

12. The method of claim 10, wherein the detected text comprises at least one of: closed-captioning text or metadata.

13. The method of claim 10, wherein the popular topic comprises at least one of search query or a hashtag topic for the time period.

14. The method of claim 10, wherein determining the plurality of content items comprising the detected text associated with the popular topic comprises:
determining, a plurality of content segments for a first content item of the plurality of content items; and
determining, at least a portion of the detected text of a first content segment of the plurality of content segments is associated with the popular topic.

15. The method of claim 10, wherein ranking the plurality of content items comprises ranking the plurality of content items in order from a most recent output time to a least recent output time.

16. The method of claim 10, further comprising:
receiving, by the computing device, a second popular topic for the time period;
determining a second plurality of content items comprising second detected text associated with the second popular topic; and
ranking, based on an output time for each of the second plurality of content items, the second plurality of content items.

17. The method of claim 10, wherein ranking the plurality of content items comprises:
determining a first portion of the plurality of content items associated with a content source; and
determining, based on the output time, a ranking order of the first portion of the plurality of content items associated with the content source.

18. A method comprising:
receiving, by a computing device, a plurality of popular topics for a time period;
determining, based on the plurality of content items, detected text for each of the plurality of content items;
determining at least a portion of the detected text is associated with at least one of the plurality of popular topics;
determining, based on a recency of an output time for each of the plurality of content items, a weighted value for each of the plurality of content items; and
generating, based on the weighted value, a ranking of the plurality of content items.

19. The method of claim 18, further comprising causing output of the ranking of the plurality of content items.

20. The method of claim 18, wherein the weighted value if greater for a more recent output time of a particular content item and less for a less recent output time of another particular content item.
